(19) United States
(12) Patent Application Publication
(10) Pub. No.: US 2026/0264524 A1
(43) Pub. Date: Sep. 10, 2026

(54) CONTROL DEVICE AND ABNORMALITY DISCERNMENT METHOD

(71) Applicant: Mitsubishi Electric Corporation, Chiyoda-ku, Tokyo (JP)

(72) Inventor: Hiroki FUJITA, Chiyoda-ku, Tokyo (JP)

(73) Assignee: Mitsubishi Electric Corporation, Chiyoda-ku, Tokyo (JP)

(21) Appl. No.: 18/875,476

(22) PCT Filed: Jul. 25, 2022
(86) PCT No.: PCT/JP2022/028569

§ 371 Date: Dec. 16, 2024

(51) Int. Cl. B60L 3/00; B60L 3/04; B60L 3/10; B60L 3/12; B60L 7/02; B60L 15/20; B61C 3/00

(52) U.S. Cl. CPC B60L 3/003; B60L 3/04; B60L 3/10; B60L 3/12; B60L 7/02; B60L 15/20; B61C 3/00; B60L 2200/26; B60L 2220/42; B60L 2240/12; B60L 2240/16; B60L 2240/26; B60L 2240/36; B60L 2240/423; B60L 2240/425; B60L 2240/46; B60L 2240/465

(57) ABSTRACT

A control device for controlling power conversion devices includes first and second arithmetic processing units connected via a transmission line. The first arithmetic processing unit includes a first calculator that determines a basic torque command value that is a torque command value common to motors arranged in a vehicle. The second arithmetic processing unit includes a second calculator that adjusts the basic torque command value based on a parameter and thereby determines, for each of the power conversion devices, a shaft torque command value that is a torque command value for one or more motors that are to receive electric power supplied from the power conversion device. The first arithmetic processing unit includes an abnormality determiner that determines, based on the basic torque command value and the shaft torque command values, presence or absence of abnormality in at least the transmission line or the second calculator.

### TECHNICAL FIELD

The present disclosure relates to a control device and an abnormality determination method.

### BACKGROUND ART

A railroad vehicle is provided with a power conversion device that converts electric power supplied from a power source into electric power to be supplied to a motor and supplies the resultant electric power to the motor, and a control device that controls multiple switching elements included in the power conversion device and thereby causes the power conversion device to perform power conversion. Some types of such control devices have a function for determining presence or absence of abnormality in components. An example of such type of a control device is disclosed in Patent Literature 1.

### CITATION LIST

### Patent Literature

Patent Literature 1: Unexamined Japanese Patent Application Kokai Publication No. H09-107602

### SUMMARY OF INVENTION

### Technical Problem

The control device disclosed in Patent Literature 1 includes an arithmetic central processing unit (CPU) and a monitoring CPU. The arithmetic CPU controls the power conversion device by generating pulse width modulation (PWM) signals in accordance with an inputted torque command and sending the PWM signals to the power conversion device. The monitoring CPU determines presence or absence of abnormality in the arithmetic CPU by comparing the torque command and a motor torque estimated from a measurement value of current flowing from the power conversion device to the motor.

The motor torque estimated from the measurement value of the current flowing from the power conversion device to the motor is affected by a disturbance. Thus, in an environment with a large disturbance, the control device disclosed in Patent Literature 1 cannot accurately determine the presence or absence of abnormality in the arithmetic CPU. This problem can occur in a control device that includes not only a CPU but also any arithmetic processing unit and executes arithmetic processing.

The present disclosure is made in view of the aforementioned circumstances, and an objective of the present disclosure is to provide a control device and an abnormality determination method that enable accurately determining presence or absence of abnormality.

### SOLUTION TO PROBLEM

To achieve the above objective, a control device according to the present disclosure is a control device for controlling power conversion devices that are installable in a railroad vehicle and include switching elements. Each of the power conversion devices is to convert electric power inputted thereto into electric power to be supplied to one or more motors and supply the electric power resulting from the conversion to the one or more motors. The control device includes a first arithmetic processing unit and a second arithmetic processing unit that are connected to each other via a transmission line. The control device includes a first calculator, a second calculator, a controller, and an abnormality determiner. The first calculator is included in the first arithmetic processing unit and determines, for each vehicle of the railroad vehicle, based on a target acceleration of the railroad vehicle and a weight of the vehicle, a basic torque command value that is a torque command value common to the motors arranged in the vehicle.

The second calculator is included in the second arithmetic processing unit and adjusts, based on a parameter indicating at least one of an operating status of a device installed in the railroad vehicle or wheel diameters of wheels rotatable with torques transmitted from the motors, the basic torque command value acquired from the first calculator via the transmission line, and thereby determines, for each of the power conversion devices, a shaft torque command value that is a torque command value for the one or more motors that are to receive the electric power supplied from the power conversion device. The controller is included in the second arithmetic processing unit, generates control signals that are each for achieving a torque indicated by a corresponding one of a plurality of the shaft torque command values and that are each directed to the switching elements included in a corresponding one of the power conversion devices, and outputs the control signals. The abnormality determiner is included in the first arithmetic processing unit and determines, based on the basic torque command value and the plurality of shaft torque command values, presence or absence of abnormality in at least one of the transmission line or the second calculator.

### ADVANTAGEOUS EFFECTS OF INVENTION

The control device according to the present disclosure includes the first arithmetic processing unit and the second arithmetic processing unit that are connected to each other via the transmission line. The abnormality determiner included in the control device determines, based on the basic torque command value determined by the first calculator of the first arithmetic processing unit and the shaft torque command values determined by the second arithmetic processing unit of the second arithmetic processing unit, presence or absence of abnormality in at least one of the transmission line or the second calculator. Due to this configuration, the control device can accurately determine presence or absence of abnormality.

### BRIEF DESCRIPTION OF DRAWINGS

FIG. 1 is a block diagram illustrating power conversion devices and a control device according to Embodiment 1;

FIG. 2 is a block diagram illustrating the control device according to Embodiment 1;

FIG. 3 is a block diagram illustrating hardware configuration of the control device according to Embodiment 1;

FIG. 4 is a flowchart of abnormality determination processing executed by the control device according to Embodiment 1;

FIG. 5 is a block diagram illustrating power conversion devices and a control device according to Embodiment 2;

FIG. 6 is a block diagram illustrating the control device according to Embodiment 2:

FIG. 7 is a block diagram illustrating hardware configuration of the control device according to Embodiment 2;

FIG. 8 is a flowchart of abnormality determination processing executed by the control device according to Embodiment 2;

FIG. 9 is a block diagram illustrating power conversion devices and a control device according to Embodiment 3;

FIG. 10 is a block diagram illustrating the control device according to Embodiment 3;

FIG. 11 is a block diagram illustrating hardware configuration of the control device according to Embodiment 3;

FIG. 12 is a flowchart of abnormality determination processing executed by the control device according to Embodiment 3;

FIG. 13 is a block diagram illustrating power conversion devices and a control device according to Embodiment 4;

FIG. 14 is a block diagram illustrating the control device according to Embodiment 4;

FIG. 15 is a block diagram illustrating hardware configuration of the control device according to Embodiment 4;

FIG. 16 is a flowchart of abnormality determination processing executed by the control device according to Embodiment 4;

FIG. 17 is a block diagram illustrating power conversion devices and a control device according to Embodiment 5;

FIG. 18 is a block diagram illustrating the control device according to Embodiment 5;

FIG. 19 is a block diagram illustrating hardware configuration of the control device according to Embodiment 5; and

FIG. 20 is a flowchart of abnormality determination processing executed by the control device according to Embodiment 5.

### DESCRIPTION OF EMBODIMENTS

A control device and an abnormality determination method according to embodiments of the present disclosure are described in detail with reference to the drawings. In the drawings, components that are the same or equivalent are assigned the same reference sign.

### Embodiment 1

As an example of a power conversion device, a direct-current to three-phase conversion device is installed in a railroad vehicle to convert electric power supplied from a power source into three-phase alternating-current power and supply such three-phase alternating-current power to a motor. A power conversion device and a control device for controlling the power conversion device according to Embodiment 1 are described using, as an example, a direct-current to three-phase conversion device installable in a railroad vehicle.

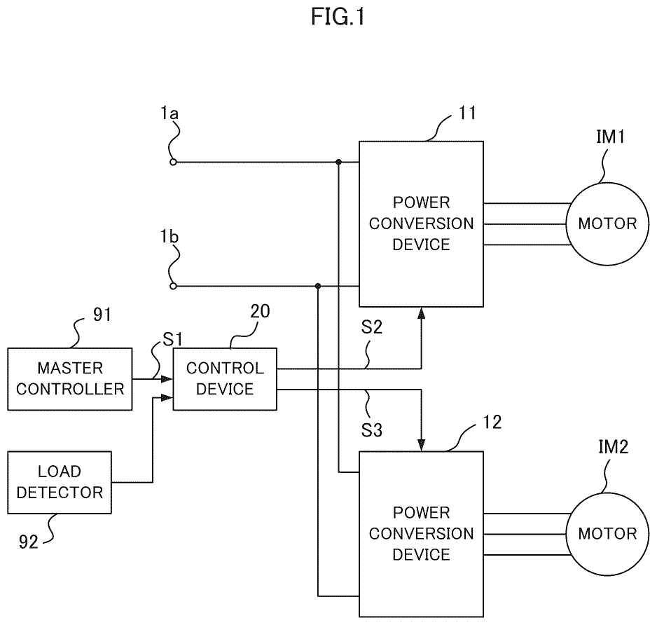

The body of each of vehicles of the railroad vehicle is typically supported by two bogies. Among the vehicles included in the railroad vehicle, a motor coach is provided with power conversion devices 11 and 12 associated with the bogies respectively and a control device 20, which are illustrated in FIG. 1. The power conversion devices 11 and 12 are direct-current to three-phase conversion devices, and the control device 20 controls the power conversion devices 11 and 12. Motors IM1 and IM2 that receive electric power supplied from the power conversion devices 11 and 12 respectively are attached to the bogies. The motors IM1 and IM2 have the same configuration. Upon driven by supply of three-phase alternating-current power, the motors IM1 and IM2 transmit torques to axles connected to shafts of the motors IMI and IM2 via gears. This operation results in generation of a driving force of the railroad vehicle. A typical example of the motors IM1 and IM2 is a three-phase induction motor.

One primary terminal of the power conversion device 11 is electrically connected to a terminal 1a to be connected to the power source, and the other primary terminal of the power conversion device 11 is electrically connected to a terminal 1b to be grounded. Secondary terminals of the power conversion device 11 are electrically connected to the motor IM1. In one example, in the case where the power conversion device 11 is installed in a railroad vehicle employing a direct-current feeding system, the power conversion device 11 includes a capacitor that is connected between the terminals 1a and 1b and that is charged with direct-current power supplied from the power source, and an inverter that converts the direct-current power supplied via the capacitor into three-phase alternating-current power.

Similarly, one primary terminal of the power conversion device 12 is electrically connected to the terminal 1a to be connected to the power source, and the other primary terminal of the power conversion device 12 is electrically connected to the terminal 1b to be grounded. Secondary terminals of the power conversion device 12 are electrically connected to the motor IM2. In one example, in the case where the power conversion device 12 is installed in a railroad vehicle employing a direct-current feeding system, the power conversion device 12 includes a capacitor that is connected between the terminals 1a and 1b and that is charged with direct-current power supplied from the power source, and an inverter that converts the direct-current power supplied via the capacitor into three-phase alternating-current power.

The inverter included in each of the power conversion devices 11 and 12 includes multiple switching elements, such as insulated gate bipolar transistors (IGBTs), gate turn-off thyristors (GTOs), or metal-oxide-semiconductor field-effect transistor (MOSFETs). The inverter performs power conversion through switching operation of the multiple switching elements.

The terminal la is preferably electrically connected, via a non-illustrated contactor, to a non-illustrated reactor, or the like, to the power source, more specifically, to a power collector that acquires electric power supplied from a power substation via a power supply line. Examples of the power collector include a pantograph for acquiring electric power through an overhead line as an example of the power supply line and a contact shoe for acquiring electric power through a third rail as an example of the power supply line. The terminal 1b is grounded with, for example, a non-illustrated ground ring, a non-illustrated ground brush, non-illustrated wheels, or the like.

The master controller 91 is arranged in, for example, a driver's cab, and outputs to the control device 20 an operation command S1 in accordance with an operation by an operator. The operation command S1 contains any of a power running command for instructing the railroad vehicle to accelerate, a braking command for instructing the railroad vehicle to decelerate, or a coasting command for instructing the railroad vehicle to coast. Both the power running command and the braking command indicate a target acceleration of the railroad vehicle. The target acceleration indicated by the power running command is positive, and the target acceleration indicated by the braking command is negative. The coasting command is taken to indicate a condition in which neither the power running command nor the braking command is included.

The load detector 92 is arranged for each of the vehicles, determines a weight of the vehicle, and transmits to the control device 20 the determined weight of the vehicle. Specifically, the load detector 92 measures the weight of the vehicle from a measurement value of a pressure inside an air chamber of air spring arranged at each bogie, and outputs the measured weight of the vehicle to the control device 20.

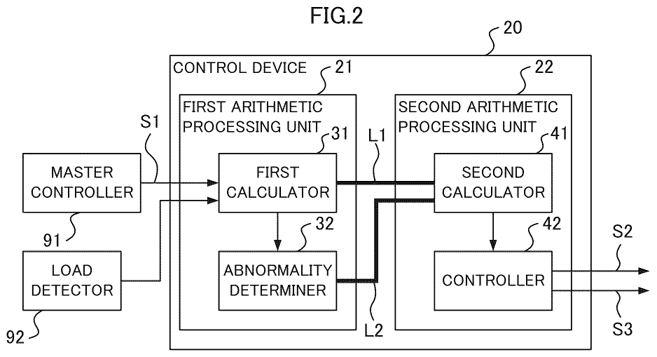

As illustrated in FIG. 2, the control device 20 includes a first arithmetic processing unit 21 and a second arithmetic processing unit 22 that are connected to each other via transmission lines L1 and L2. The first arithmetic processing unit 21 includes a first calculator 31 that determines, for each of the vehicles, from the operation command S1 and the weight of the vehicle, a basic torque command value that is a torque command value common to the motors arranged in the vehicle, and an abnormality determiner 32 that determines presence or absence of abnormality in at least one of the transmission line L1, the transmission line L2, or a second calculator 41 included in the second arithmetic processing unit 22.

The second arithmetic processing unit 22 includes the second calculator 41 that adjusts, based on a parameter, the basic torque command value acquired via the transmission line L1, and thereby determines, for each of the power conversion devices, a shaft torque command value that is a torque command value for the motor that is to receive electric power supplied from the power conversion device. The parameter indicates at least one of an operating status of a device installed in the railroad vehicle or wheel diameters of wheels that rotate with torques transmitted from the motors IMI and IM2. Specifically, the operating status of a device installed in the railroad vehicle indicates an operating status of the power conversion devices 11 and 12, an operating status of a device electrically connected to the power conversion devices 11 and 12, a status of wheels of the railroad vehicle, and the like. The devices electrically connected to the power conversion devices 11 and 12 include electronic components, in-vehicle devices, and the like, which are electrically connected to the power conversion devices 11 and 12.

In detail, the operating status of a device installed in the railroad vehicle includes at least one of temperatures of the motors IM1 and IM2, temperatures of the power conversion devices 11 and 12, presence or absence of slip or skid of wheels attached to the axles of the railroad vehicle, or a temperature of a brake resistor that consumes electric power that is output from the motors IM1 and IM2 operating as power generators during deceleration of the railroad vehicle and that is converted by the power conversion devices 11 and 12 so as to generate an electric braking force. In Embodiment 1, the temperatures of the motors IM1 and IM2 are used as the operating status. The second arithmetic processing unit 22 further includes a controller 42 that generates control signals S2 and S3 directed to the power conversion devices 11 and 12 for achieving a torque indicated by the shaft torque command value.

The first calculator 31 determines the basic torque command value that is the torque command value common to the motors in the same vehicle, including the motors IM1 and IM2. The first calculator 31 is taken to hold, as a reference value, a torque for each of the vehicles in a state where a notch of the master controller 91 is at a maximum and the vehicles are empty. The first calculator 31 calculates the basic torque command value by, for example, multiplying the reference value by a ratio of the target acceleration indicated by the operation command acquired from the master controller 91 to acceleration corresponding to a maximum notch and a ratio of the weight of the vehicle acquired from the load detector 92 to a weight of the vehicle that is empty.

In the case where the operation command S1 indicates the power running command, the basic torque command value corresponds to a target value of a power running torque needed for the railroad vehicle to accelerate at the target acceleration indicated by the operation command S1. In the case where the operation command S1 indicates the braking command, the basic torque command value corresponds to a target value of an electric braking torque needed for the railroad vehicle to decelerate at the target deceleration indicated by the operation command S1. In the case where neither the power running command nor the braking command is indicated by the operation command S1, that is, the operation command S1 indicates an instruction of a coasting operation, the first calculator 31 sets the basic torque command value to a value that can be deemed as 0.

The second calculator 41 determines, for each of the power conversion devices 11 and 12, the shaft torque command value that is the torque command value for a corresponding one of the motors IMI and IM2 that receive electric power from the power conversion devices 11 and 12. The second calculator 41 calculates the shaft torque command value for each of the motors IM1 and IM2 by multiplying the basic torque command value by a parameter indicating the wheel diameter of the wheels that rotate with a torque obtained from a corresponding one of the motors IM1 and IM2. The second calculator 41 is taken to hold, in advance, information of the parameter.

In one example, the second calculator 41 calculates a shaft torque command value Tr1 by multiplying a basic torque command value Tr0 by a parameter R1 indicating the wheel diameter of the wheels corresponding to the motor IM1. The shaft torque command value Tr1 is expressed as Tr1=Tr0×R1. The second calculator 41 calculates a shaft torque command value Tr2 by multiplying the basic torque command value Tr0 by a parameter R2 indicating the wheel diameter of the wheels corresponding to the motor IM2. The shaft torque command value Tr2 is expressed as Tr2=Tr0×R2. The parameters R1 and R2 are each a parameter positively correlated with a magnitude of the wheel diameter and is 1 when the wheel diameter matches the reference value. When there is no difference in the wheel diameter and R1=R2=1, then Tr0=Tr1=Tr2. The second calculator 41 transmits the shaft torque command values Tr1 and Tr2 determined as above to the abnormality determiner 32 via the transmission line L2.

The controller 42 generates the control signals S2 and S3 for achieving torques indicated by the shaft torque command values Tr1 and Tr2 for the motors IM1 and IM2 that are determined by the second calculator 41. Each of the control signals S2 and S3 is, for example, a pulse width modulation (PWM) signal. The controller 42 sends the PWM signal to each of the switching elements of a converter and the inverter that are included in the power conversion devices 11 and 12 and thereby controls each of the switching elements.

During power running of the railroad vehicle, with the switching elements of the power conversion devices 11 and 12 performing the switching operation upon receiving the PWM signals from the controller 42, the power conversion devices 11 and 12 convert the electric power supplied from the power source into three-phase alternating-current power and supply to the motors IM1 and IM2. As a result, the railroad vehicle accelerates in accordance with the target acceleration indicated by the operation command S1.

During braking of the railroad vehicle, with the switching elements of the power conversion devices 11 and 12 performing the switching operation upon receiving the PWM signals from the controller 42, the power conversion devices 11 and 12 convert the three-phase alternating-current power supplied from the motors IM1 and IM2 operating as power generators into electric power that can be supplied to other railroad vehicles located nearby via an overhead wire. Supplying the electric power resulting from the conversion of the power conversion devices 11 and 12 to the other railroad vehicles that are located nearby and are in power running causes the electric power generated by the motors IM1 and IM2 operating as power generators to be consumed. This results in generation of an electric braking force. As a result, the railroad vehicle decelerates in accordance with the target acceleration indicated by the operation command S1.

The abnormality determiner 32 determines, based on the basic torque command value acquired from the first calculator 31 and the shaft torque command values acquired from the second calculator 41, presence or absence of abnormality in at least one of the transmission line L1, the transmission line L2, or the second calculator 41. As described above, when there is no difference in the wheel diameter between the wheels that obtain torques from the motors IM1 and IM2, “Tr0=Tr1=Tr2” is satisfied on condition that abnormality is not occurring in any of the transmission line L1, the transmission line L2, and the second calculator 41. Thus, the abnormality determiner 32 determines whether the basic torque command value Tr0 and each of the shaft torque command values Tr1 and Tr2 match. The term “match” herein does not mean exact matching of the basic torque command value Tr0 and each of the shaft torque command values Tr1 and Tr2 and means that degrees of discrepancy of the shaft torque command values Tr1 and Tr2 from the basic torque command value Tr0 are within a tolerance range. In detail, the abnormality determiner 32 determines, based on differences between the basic torque command value Tr0 and the shaft torque command values Tr1 and Tr2, presence or absence of abnormality in at least one of the transmission line L1, the transmission line L2, or the second calculator 41.

For example, the abnormality determiner 32 determines, for each of the shaft torque command values Tr1, whether an absolute value ΔTd1=|Tr1−Tr0| being an absolute value of a difference between the basic torque command value Tr0 and the shaft torque command value Tr1 is greater than a command threshold. When the absolute value of the difference ΔTd1 is greater than the command threshold, it can be deemed that abnormality is occurring in at least one of the transmission line L1, the transmission line L2, or the second calculator 41. When the absolute value of the difference ΔTd1 is equal to or lower than the command threshold, it can be deemed that abnormality is not occurring in any of the transmission line L1, the transmission line L2 and the second calculator 41.

The command threshold is defined, through simulation, test driving, or the like, based on possible values of the differences between the basic torque command value and each of the shaft torque command values. For example, the abnormality determiner 32 uses, as the command threshold, a value that is sufficiently greater than possible values of the absolute value of the differences between the basic torque command value and each of the shaft torque command values, more specifically, a value within the range of 100 N m or more and 500 N m or less.

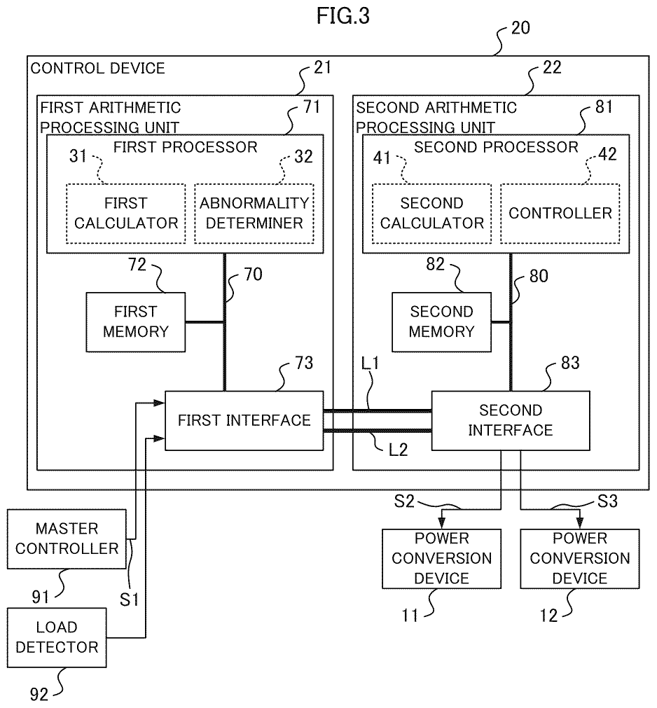

FIG. 3 illustrates hardware configuration of the control device 20 having the above configuration. The first arithmetic processing unit 21 includes a first processor 71 including a central processing unit (CPU), a micro processing unit (MPU), or the like, a first memory 72 storing a command for causing the first processor 71 to function as the first calculator 31 and the abnormality determiner 32, and a first interface 73 that communicates with the second arithmetic processing unit 22 via the transmission lines L1 and L2. The first processor 71, the first memory 72, and the first interface 73 are connected to one another with a bus 70.

The functions of the first arithmetic processing unit 21, more specifically, the functions of the first calculator 31 and the abnormality determiner 32, are achieved by software, firmware, or a combination of software and firmware. The software and the firmware are described as programs and are stored in the first memory 72. The first processor 71 reads and executes the programs stored in the first memory 72 to achieve the functions of the above components. That is, the first memory 72 stores programs for execution of the processing by the first arithmetic processing unit 21.

The first memory 72 includes, for example, a nonvolatile or volatile semiconductor memory such as a random-access memory (RAM), a read-only memory (ROM), a flash memory, an erasable programmable read only memory (EPROM), or an electrically erasable and programmable read only memory (EEPROM), a magnetic disk, a flexible disk, an optical disc, a compact disc, a minidisc, or a digital versatile disc (DVD).

The first arithmetic processing unit 21 is connected to the master controller 91 and the load detector 92 via the first interface 73. The first interface 73 includes an interface module complying with one or more standards as appropriate for connection targets.

The second arithmetic processing unit 22 includes a second processor 81 including a CPU, an MPU, or the like, a second memory 82 storing a command for causing the second processor 81 to function as the second calculator 41 and the controller 42, and a second interface 83 that communicates with the first arithmetic processing unit 21 via the transmission lines L1 and L2. The second processor 81, the second memory 82, and the second interface 83 are connected to one another with a bus 80.

The functions of the second arithmetic processing unit 22, more specifically, the functions of the second calculator 41 and the controller 42, are achieved by software, firmware, or a combination of software and firmware. The software and the firmware are described as programs and are stored in the second memory 82. The second processor 81 reads and executes the programs stored in the second memory 82 to achieve the functions of the above components. That is, the second memory 82 stores programs for execution of the processing by the second arithmetic processing unit 22. The second processor 81 includes a CPU, an MPU, or the like.

The second memory 82 includes, for example, a nonvolatile or volatile semiconductor memory such as a RAM, a ROM, a flash memory, an EPROM, or an EEPROM, a magnetic disk, a flexible disk, an optical disc, a compact disc, a minidisc, a DVD, or the like.

The second arithmetic processing unit 22 is connected to the power conversion devices 11 and 12 via the second interface 83. The second interface 83 includes an interface module complying with one or more standards as appropriate for connection targets.

The first interface 73 and the second interface 83 are connected to each other via the transmission lines L1 and L2. The transmission lines L1 and L2 are, for example, pattern wiring of a substrate on which the first arithmetic processing unit 21 and the second arithmetic processing unit 22 are mounted.

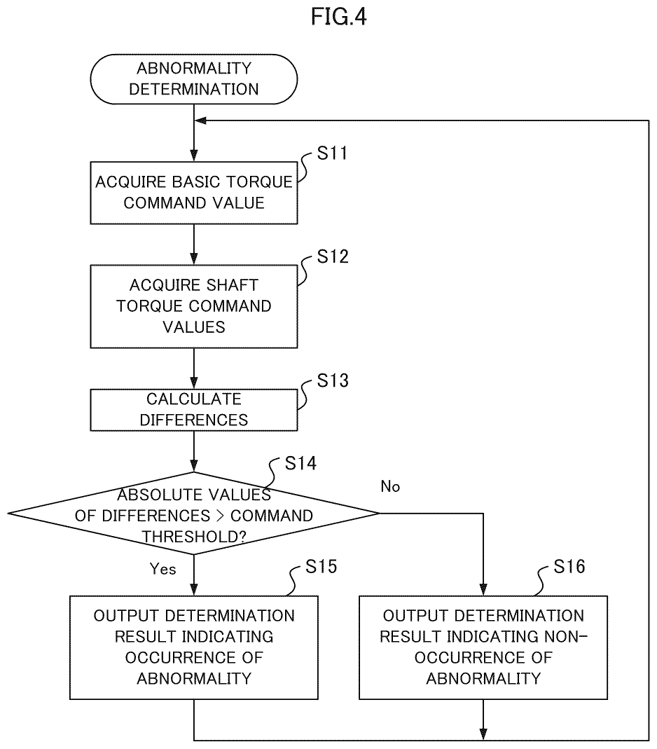

Abnormality determination processing executed by the control device 20 having the aforementioned configuration is described with reference to FIG. 4. The control device 20 starts the operation illustrated in FIG. 4 upon acquiring the operation command S1 from the master controller 91. The abnormality determiner 32 acquires the basic torque command value from the first calculator 31 (step S11). The abnormality determiner 32 acquires the shaft torque command values form the second calculator 41 via the transmission line L2 (step S12).

The abnormality determiner 32 calculates differences between the basic torque command value acquired from the first calculator 31 in step S11 and each of the shaft torque command values acquired from the second calculator 41 via the transmission line L2 in step S12 (step S13). The abnormality determiner 32 acquires the basic torque command value from the first calculator 31 achieved by the first processor 71 that achieves the abnormality determiner 32. Thus, even in the case of occurrence of abnormality in any of the transmission lines L1 and L2, this abnormality does not affect the basic torque command value acquired by the abnormality determiner 32.

The abnormality determiner 32 acquires, via the transmission line L2, the shaft torque command values determined by the second calculator 41 through arithmetic processing of the basic torque command value transmitted via the transmission line L1. Thus, upon occurrence of abnormality in at least one of the transmission line L1, the transmission line L2, or the second calculator 41, the shaft torque command values greatly change from values at a time when abnormality is not occurring in any of the transmission line L1, the transmission line L2, and the second calculator 41. In other words, upon occurrence of abnormality in at least one of the transmission line L1, the transmission line L2, or the second calculator 41, discrepancy occurs between the basic torque command value and the shaft torque command values.

The abnormality determiner 32 determines whether absolute values of the differences calculated in step S13 are greater than the command threshold (step S14). When at least one of the absolute values of the differences calculated in step S13 is greater than the command threshold (YES in step S14), the abnormality determiner 32 outputs a determination result indicating occurrence of abnormality (step S15). For example, the abnormality determiner 32 outputs a determination result indicating occurrence of abnormality in an external device such as a display device arranged in the driver's cab.

When the absolute values of the differences calculated in step S14 are equal to or less than the command threshold (NO in step S14), the abnormality determiner 32 outputs a determination result indicating non-occurrence of abnormality (step S16). For example, the abnormality determiner 32 outputs a determination result indicating non-occurrence of abnormality in the display device arranged in the driver's cab. After completion of the processing in step S15 or step S16, the control device 20 repeats the aforementioned processing from step S11.

As described above, the control device 20 according to Embodiment 1 includes the first arithmetic processing unit 21 and the second arithmetic processing unit 22 that are connected to each other via the transmission lines L1 and L2. The abnormality determiner 32 included in the first arithmetic processing unit 21 determines, based on the basic torque command value determined by the first calculator 31 included in the first arithmetic processing unit 21 and the shaft torque command values determined by the second calculator 41 included in the second arithmetic processing unit 22, presence or absence of abnormality in at least one of the transmission line L1, the transmission line L2, or the second calculator 41. Since a value measured with a sensor is not used for determination of presence or absence of abnormality, the control device 20 is not affected by a disturbance and thus can accurately determine presence or absence of abnormality.

### Embodiment 2

The method for determining the shaft torque command values and the abnormality determination method are not limited to the above examples. In Embodiment 2, a control device 20 that determines the shaft torque command value and determines presence or absence of abnormality in methods different from the methods of Embodiment 1 is described focusing on differences from Embodiment 1.

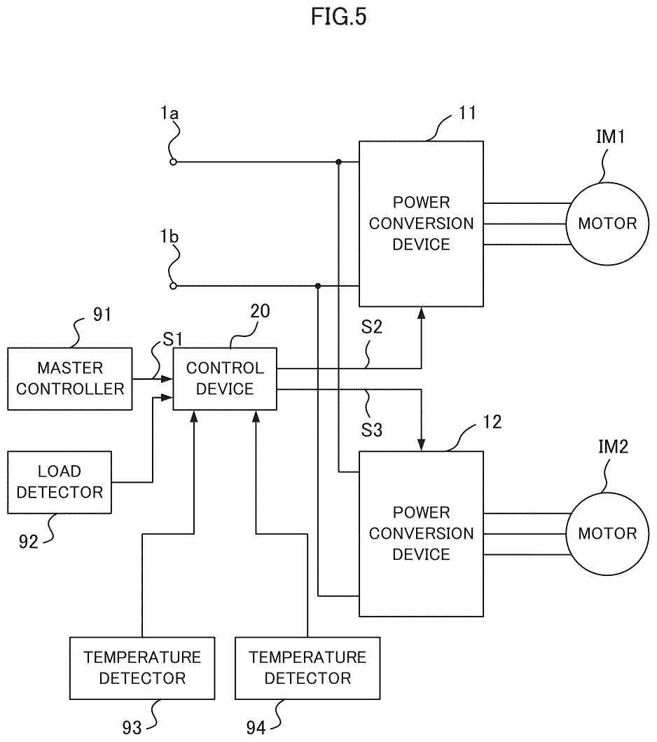

As illustrated in FIG. 5, the control device 20 according to Embodiment 2 acquires the temperatures of the motors IM1 and IM2 from temperature detectors 93 and 94 that determine the temperatures of the motors IM1 and IM2. The temperature detectors 93 and 94 determine the temperatures of the motors IM1 and IM2, respectively, based on, for example, measurement values of thermocouples arranged at positions adjacent to stator coils of the motors IM1 and IM2.

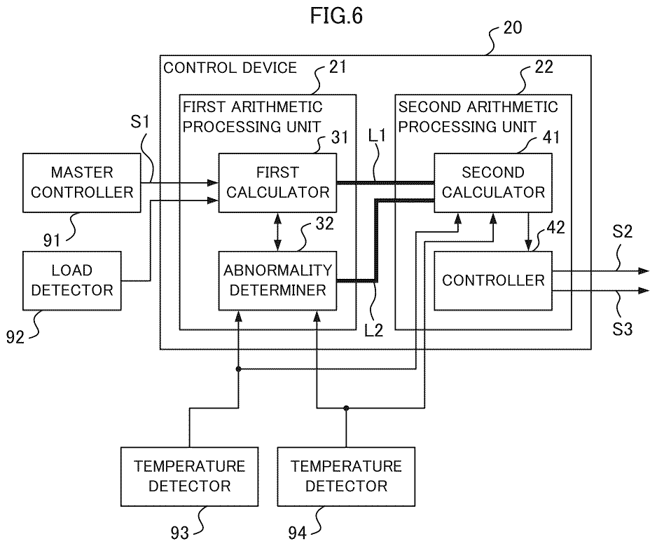

As illustrated in FIG. 6, the configuration of the control device 20 is similar to that of Embodiment 1. Each of the abnormality determiner 32 and the second calculator 41 acquires the temperatures of the motors IM1 and IM2 from the temperature detectors 93 and 94.

The second calculator 41 adjusts the basic torque command value based on parameters indicating the temperatures of the motors IM1 and IM2 and thereby determines the shaft torque command value for each of the motors IM1 and IM2. In detail, the second calculator 41 calculates the shaft torque command value for each of the motors IM1 and IM2 by multiplying the basic torque command value by the parameter indicating the wheel diameter of the wheels that rotate with a torque obtained from a corresponding one of the motors IM1 and IM2 and by a parameter indicating a corresponding one of the temperatures of the motors IM1 and IM2.

In one example, the second calculator 41 calculates a shaft torque command value Tr1 by multiplying a basic torque command value Tr0 by a parameter R1 indicating the wheel diameter of the wheels corresponding to the motor IM1 and by a parameter Th1 indicating the temperature of the motor IM1. The shaft torque command value Tr1 is expressed as Tr1=Tr0×R1×Th1. The second calculator 41 calculates a shaft torque command value Tr2 by multiplying the basic torque command value Tr0 by a parameter R2 indicating the wheel diameter of the wheels corresponding to the motor IM2 and by a parameter Th2 indicating the temperature of the motor IM2. The shaft torque command value Tr2 is expressed as Tr2=Tr0×R2×Th2.

Each of the parameter Th1 indicating the temperature of the motor IM1 and the parameter Th2 indicating the temperature of the motor IM2 is a value greater than or equal to 0 and less than or equal to 1, and is a parameter negatively correlated with the temperature of a corresponding one of the motors IM1 and IM2 at a high-temperature range. In detail, when the temperatures of the motors IM1 and IM2 are within a first target temperature range, the parameters Th1 and Th2 are 1, and when the temperatures of the motors IM1 and IM2 are higher than the first target temperature range, the parameters Th1 and Th2 are less than 1. As the temperatures of the motors IM1 and IM2 increase above an upper limit of the first target temperature range, the values of the parameters Th1 and Th2 approach 0. The first target temperature range is set lower than an allowable temperature of the motors IM1 and IM2, in other words, a temperature that the motors IM1 and IM2 can withstand. The second calculator 41 is taken to hold, in advance, information of the parameters and the first target temperature range.

When the temperatures of the motors IM1 and IM2 are higher than the first target temperature range, since the parameters Th1 and Th2 are a value less than 1, the shaft torque command values Tr1 and Tr2 become small as compared to the case where the temperatures of the motors IM1 and IM2 are within the first target temperature range.

A decrease in the shaft torque command values Tr1 and Tr2 leads to a decrease in currents flowing into the motors IM1 and IM2 from the power conversion devices 11 and 12 controlled with control signals S2 and S3 for achieving torques indicated by the shaft torque command values Tr1 and Tr2, resulting in suppression of an increase in the temperatures of the motors IM1 and IM2.

The second calculator 41 transmits the shaft torque command values Tr1 and Tr2 determined as above to the abnormality determiner 32 via the transmission line L2.

The abnormality determiner 32 determines, when the operating status satisfies a determination condition, based on the basic torque command value acquired from the first calculator 31 and the shaft torque command values acquired from the second calculator 41, presence or absence of abnormality in at least one of the transmission line L1, the transmission line L2, or the second calculator 41. In detail, when both of the temperatures of the motors IM1 and IM2 are within the first target temperature range, the abnormality determiner 32 determines whether the basic torque command value Tr0 and each of the shaft torque command values Tr1 and Tr2 match. For example, when both of the temperatures of the motors IM1 and IM2 are within the first target temperature range, the abnormality determiner 32 determines, based on differences between the basic torque command value Tr0 and each of the shaft torque command values Tr1 and Tr2, presence or absence of abnormality in at least one of the transmission line L1, the transmission line L2, or the second calculator 41. The abnormality determiner 32 is taken to hold, in advance, information of the first target temperature range.

When at least one of the temperatures of the motors IM1 and IM2 is not within the first target temperature range, the abnormality determiner 32 does not make a determination of presence or absence of abnormality based on the differences between the basic torque command value Tr0 and each of the shaft torque command values Tr1 and Tr2. This suppresses erroneously determining that abnormality is occurring in at least one of the transmission line L1, the transmission line L2, or the second calculator 41 when the shaft torque command values Tr1 and Tr2 are set low due to the temperatures of the motors IM1 and IM2 not being within the first target temperature range.

The control device 20 may perform not only the determination of presence or absence of abnormality in at least one of the transmission line L1, the transmission line L2, or the second calculator 41 but also a protection operation in response to occurrence of abnormality. In detail, the abnormality determiner 32 transmits the result of the determination of presence or absence of abnormality to the first calculator 31. When the determination result acquired from the abnormality determiner 32 indicates occurrence of abnormality, the first calculator 31 sets the basic torque command value to a value to stop the power conversion devices 11, 12, specifically, to 0. When the basic torque command value is set to 0, the shaft torque command value determined by the second calculator 41 also becomes 0. As a result, the controller 42 outputs the switching control signals S2 and S3 for turning off the switching elements of the power conversion devices 11 and 12.

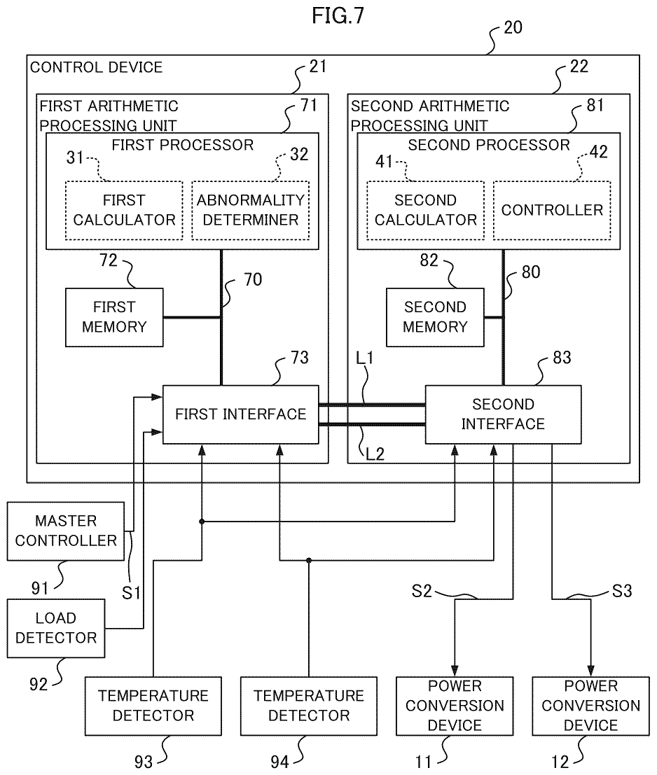

FIG. 7 illustrates hardware configuration of the control device 20 having the above configuration. The control device 20 has the same hardware configuration as that in Embodiment 1.

The first arithmetic processing unit 21 is connected to the master controller 91, the load detector 92, and the temperature detectors 93 and 94, via the first interface 73. The first interface 73 includes an interface module complying with one or more standards as appropriate for connection targets.

The second arithmetic processing unit 22 is connected to the temperature detectors 93 and 94 and the power conversion devices 11 and 12 via the second interface 83. The second interface 83 includes an interface module complying with one or more standards as appropriate for connection targets.

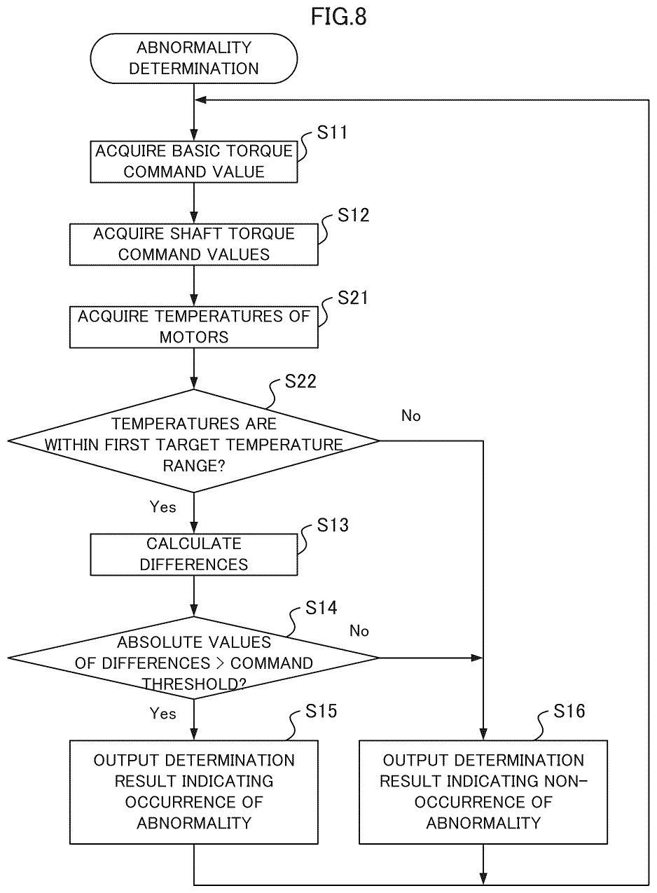

The abnormality determination processing executed by the control device 20 having the aforementioned configuration is described with reference to FIG. 8. The control device 20 starts the operation illustrated in FIG. 8 upon acquiring the operation command S1 from the master controller 91. Processing in steps S11 and S12 is similar to the processing in steps S11 and S12 as illustrated in FIG. 4 that is executed by the control device 20 according to Embodiment 1.

The abnormality determiner 32 acquires the temperatures of the motors IM1 and IM2 from the temperature detectors 93 and 94 (step S21). The abnormality determiner 32 determines whether the temperatures of the motors IM1 and IM2 are within the first target temperature range (step S22).

When the temperatures of the motors IM1 and IM2 are within the first target temperature range (YES in step S22), the abnormality determiner 32 executes the processing in steps S13 through S15 similarly to Embodiment 1. In step S15, the abnormality determiner 32 outputs the determination result to the first calculator 31 and the external device. When at least one of the temperatures of the motors IM1 and IM2 is not within the first target temperature range (NO in step S22), the abnormality determiner 32 outputs, to the first calculator 31 and the external device, the determination result indicating non-occurrence of abnormality (step S16). After completion of the processing in step S15 or step S16, the control device 20 repeats the aforementioned processing from step S11.

As described above, the second calculator 41 included in the control device 20 according to Embodiment 2 adjusts the basic torque command value based on the parameters indicating the temperatures of the motors IM1 and IM2 and thereby determines the shaft torque command values. As described above, the shaft torque command values for the temperatures of the motors IM1 and IM2 that are higher than the first target temperature range are made to be less than the shaft torque command values for the temperatures of the motors IM1 and IM2 that are within the first target temperature range, leading to suppression of an increase in the temperatures of the motors IM1 and IM2.

When the temperatures of the motors IM1 and IM2 are not within the first target temperature range, the abnormality determiner 32 does not make a determination of presence or absence of abnormality in the transmission lines L1 and L2 and the second calculator 41, and outputs the determination result indicating non-occurrence of abnormality in the transmission lines L1 and L2 and the second calculator 41. This suppresses erroneously determining that abnormality is occurring in at least one of the transmission line L1, the transmission line L2, or the second calculator 41 when the shaft torque command values Tr1 and Tr2 are set low due to the temperatures of the motors IM1 and IM2 not being within the first target temperature range.

### Embodiment 3

The method for determining the shaft torque command values and the abnormality determination method are not limited to the above examples. In Embodiment 3, a control device 23 that determines the shaft torque command values and determines presence or absence of abnormality in methods different from the methods of Embodiments 1 and 2 is described focusing on differentiating points from Embodiments 1 and 2.

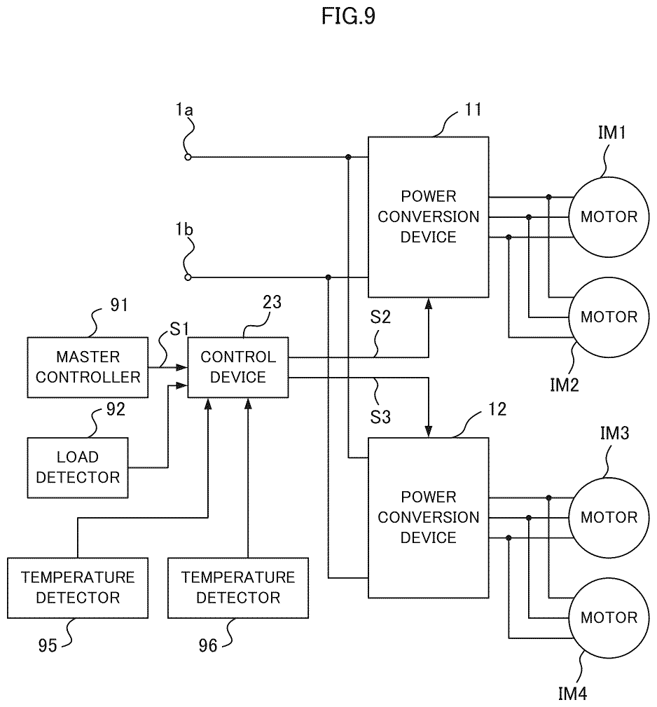

The control device 23 illustrated in FIG. 9 is arranged at each motor coach. The control device 23 sends control signals S2 and S3 to power conversion devices 11 and 12, respectively, to control the power conversion devices 11 and 12. The power conversion device 11 controlled by the control device 23 supplies electric power to motors IM1 and IM2 attached to one bogie of the motor coach. The power conversion device 12 controlled by the control device 23 supplies electric power to motors IM3 and IM4 attached to the other bogie of the motor coach. The motors IM1, IM2, IM3, and IM4 have the same configuration.

The control device 23 acquires, from temperature detectors 95 and 96 that determine the temperatures of the power conversion devices 11 and 12, the temperatures of the power conversion devices 11 and 12. The temperature detectors 95 and 96 determine the temperatures of the power conversion devices 11 and 12 based on, for example, measurement values of temperature sensors arranged at positions adjacent to the switching elements of the power conversion devices 11 and 12.

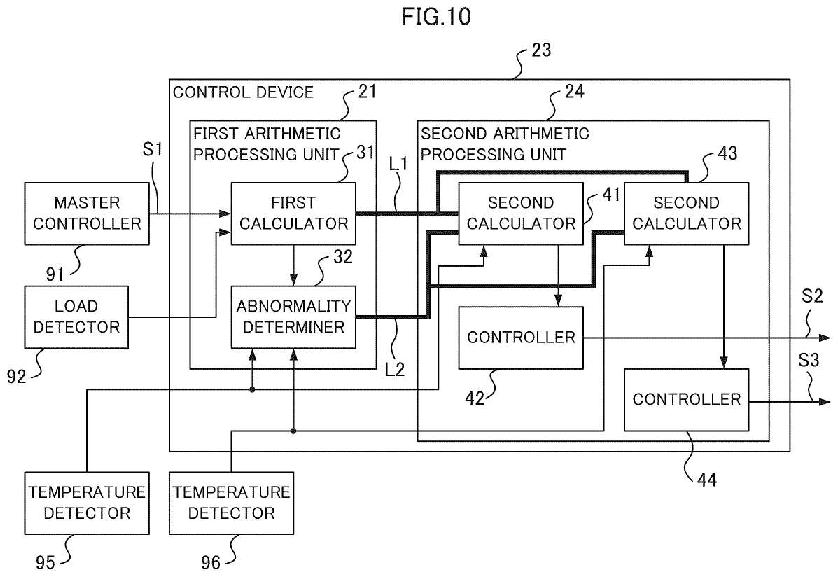

As illustrated in FIG. 10, the control device 23 includes a first arithmetic processing unit 21 and a second arithmetic processing unit 24 that are connected to each other via transmission lines L1 and L2. The second arithmetic processing unit 24 includes a second calculator 41 that determines the shaft torque command value for the motors IM1 and IM2 based on the basic torque command value acquired via the transmission line L1 and the temperature of the power conversion device 11, and a controller 42 that generates control signals S2 directed to the power conversion device 11 for achieving a torque indicated by the shaft torque command value determined by the second calculator 41. The second arithmetic processing unit 24 further includes a second calculator 43 that determines the shaft torque command value for the motors IM3 and IM4 based on the basic torque command value acquired via the transmission line L1 and the temperature of the power conversion device 12, and a controller 44 that generates control signals S3 directed to the power conversion device 12 for achieving a torque indicated by the shaft torque command values determined by the second calculator 43.

The second calculator 41 calculates the shaft torque command value common to the motors IM1 and IM2 by multiplying the basic torque command value by a parameter indicating the wheel diameters of the wheels that each rotate with a torque obtained from a corresponding one of the motors IM1 and IM2 and by a parameter indicating the temperature of the power conversion device 11. The second calculator 43 calculates the shaft torque command value common to the motors IM3 and IM4 by multiplying the basic torque command value by a parameter indicating the wheel diameters of the wheels that each rotate with a torque obtained from a corresponding one of the motors IM3 and IM4 and by a parameter indicating the temperature of the power conversion device 12.

In one example, the second calculator 41 calculates a shaft torque command value Tr1 by multiplying a basic torque command value Tr0 by a parameter R′1 indicating an average value of the wheel diameter of the wheels corresponding to the motor IM1 and the wheel diameter of the wheels corresponding to the motor IM2 and by a parameter Th′1 indicating the temperature of the power conversion device 11. The shaft torque command value Tr1 is expressed as Tr1=Tr0×R′1×Th′1. The second calculator 43 calculates a shaft torque command value Tr2 by multiplying the basic torque command value Tr0 by a parameter R′2 indicating an average value of the wheel diameter of the wheels corresponding to the motor IM3 and the wheel diameter of the wheels corresponding to the motor IM4 and by a parameter Th′2 indicating the temperature of the power conversion device 12. The shaft torque command value Tr2 is expressed as Tr2=Tr0×R′2×Th′2.

Each of the parameter Th′1 indicating the temperature of the power conversion device 11 and the parameter Th′2 indicating the temperature of the power conversion device 12 is a value greater than or equal to 0 and less than or equal to 1, and is a parameter negatively correlated with the temperature of a corresponding one of the power conversion devices 11 and 12 at a high-temperature range. In detail, when the temperatures of the power conversion devices 11 and 12 are within a second target temperature range, the parameters Th′1 and Th′2 are 1, and when the temperatures of the power conversion devices 11 and 12 are higher than the second target temperature range, the parameters Th′1 and Th′2 are less than 1. As the temperatures of the power conversion devices 11 and 12 increase above an upper limit of the second target temperature range, the values of the parameters Th′1 and Th′2 approach 0. The second target temperature range is set lower than an allowable temperature of switching elements of the power conversion devices 11 and 12, in other words, a temperature that the power conversion devices 11 and 12 can withstand. The second calculators 41 and 43 are taken to hold, in advance, information of the parameters and the second target temperature range.

The controller 42 generates the control signals S2 for achieving a torque indicated by the shaft torque command value Tr1 that is common to the motors IM1 and IM2 and that is determined by the second calculator 41. The controller 42 sends the PWM signal to each of the switching elements of the inverter that is included in the power conversion device 11 and thereby controls each of the switching elements. The controller 44 generates the control signals S3 for achieving a torque indicated by the shaft torque command value Tr2 that is common to the motors IM3 and IM4 and that is determined by the second calculator 43. The controller 44 sends the PWM signal to each of the switching elements of the inverter that is included in the power conversion device 12 and thereby controls each of the switching elements.

When the temperatures of the power conversion devices 11 and 12 are higher than the second target temperature range, since the parameters Th′1 and Th′2 are a value less than 1, the shaft torque command values Tr1 and Tr2 become small as compared to the case where the temperatures of the power conversion devices 11 and 12 are within the second target temperature range. A decrease in the shaft torque command values Tr1 and Tr2 leads to a decrease in outputs from the power conversion devices 11 and 12 controlled with the control signals S2 and S3 for achieving torques indicated by the shaft torque command values Tr1 and Tr2, resulting in suppression of an increase in the temperatures of the power conversion devices 11 and 12.

The second calculators 41 and 43 transmit the shaft torque command values Tr1 and Tr2 determined as above to the abnormality determiner 32 via the transmission line L2.

The abnormality determiner 32 determines, when the operating status satisfies a determination condition, based on the basic torque command value acquired from the first calculator 31 and the shaft torque command values acquired from the second calculators 41 and 43, presence or absence of abnormality in at least one of the transmission line L1, the transmission line L2, the second calculator 41, or the second calculator 43. In detail, when both of the temperatures of the power conversion devices 11 and 12 are within the second target temperature range, the abnormality determiner 32 determines whether the basic torque command value Tr0 and each of the shaft torque command values Tr1 and Tr2 match. For example, when both of the temperatures of the power conversion devices 11 and 12 are within the second target temperature range, the abnormality determiner 32 determines, based on differences between the basic torque command value Tr0 and each of the shaft torque command values Tr1 and Tr2, presence or absence of abnormality in at least one of the transmission line L1, the transmission line L2, the second calculator 41, or the second calculator 43. The abnormality determiner 32 is taken to hold, in advance, information of the second target temperature range.

When at least one of the temperatures of the power conversion devices 11 and 12 is not within the second target temperature range, the abnormality determiner 32 does not make a determination of presence or absence of abnormality based on the differences between the basic torque command value Tr0 and each of the shaft torque command values Tr1 and Tr2. This suppresses erroneously determining that abnormality is occurring in at least one of the transmission line L1, the transmission line L2, the second calculator 41, or the second calculator 43 when the shaft torque command values Tr1 and Tr2 are set low due to the temperatures of the power conversion devices 11 and 12 not being within the second target temperature range.

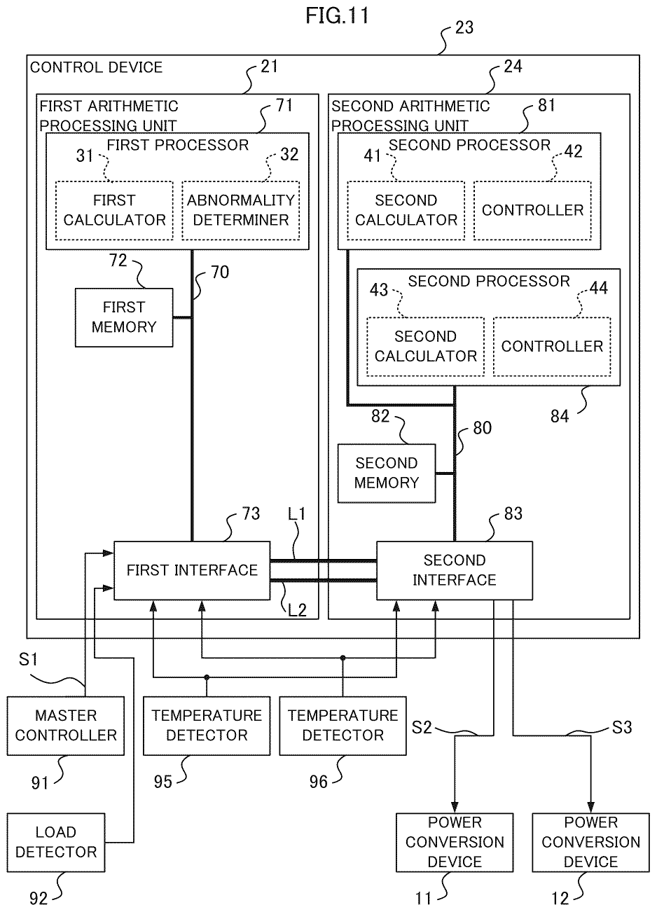

FIG. 11 illustrates hardware configuration of the control device 23 having the above configuration. The configuration of the first arithmetic processing unit 21 is similar to that of Embodiment 1. The second arithmetic processing unit 24 includes second processors 81 and 84, a second memory 82, and a second interface 83. The second processors 81 and 84, the second memory 82, and the second interface 83 are connected to one another with a bus 80.

The functions of the second arithmetic processing unit 24, more specifically, the functions of the second calculators 41 and 43 and the controllers 42 and 44, are achieved by software, firmware, or a combination of software and firmware. The software and the firmware are described as programs and are stored in the second memory 82. The second processor 81 reads and executes the programs stored in the second memory 82 to achieve the functions of the second calculator 41 and the controller 42. The second processor 84 reads and executes the programs stored in the second memory 82 to achieve the functions of the second calculator 43 and the controller 44. That is, the second memory 82 stores programs for execution of the processing by the second arithmetic processing unit 24. The second processors 81 and 84 include a CPU, an MPU, or the like.

The second memory 82 includes, for example, a nonvolatile or volatile semiconductor memory such as a RAM, a ROM, a flash memory, an EPROM, or an EEPROM, a magnetic disk, a flexible disk, an optical disc, a compact disc, a minidisc, a DVD, or the like.

The first arithmetic processing unit 21 is connected to the master controller 91, the load detector 92, and the temperature detectors 95 and 96, via the first interface 73. The first interface 73 includes an interface module complying with one or more standards as appropriate for connection targets.

The second arithmetic processing unit 24 is connected to the temperature detectors 95 and 96 and the power conversion devices 11 and 12 via the second interface 83. The second interface 83 includes an interface module complying with one or more standards as appropriate for connection targets.

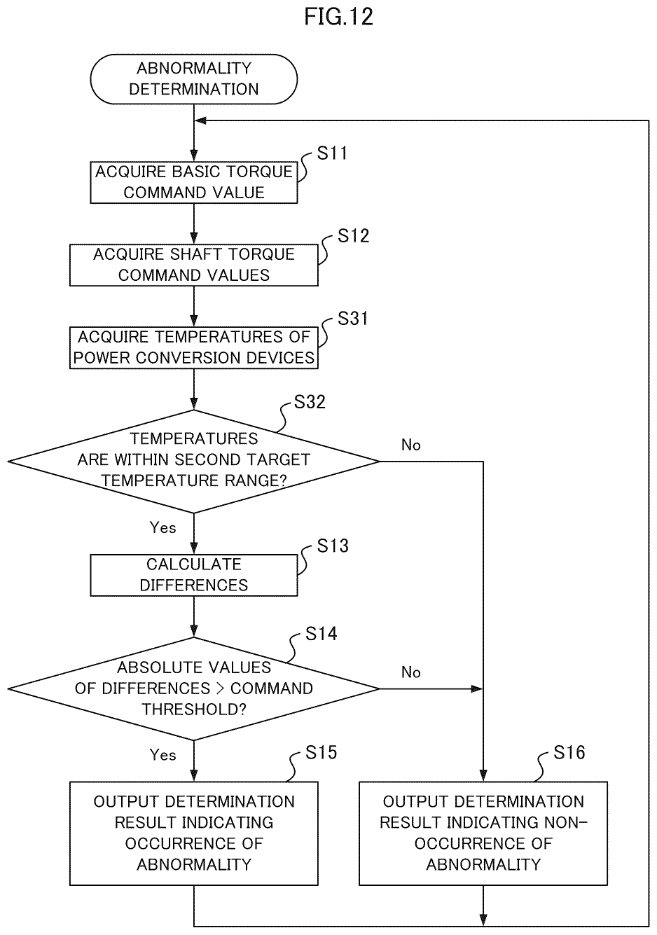

The abnormality determination processing executed by the control device 23 having the aforementioned configuration is described with reference to FIG. 12. The control device 23 starts the operation illustrated in FIG. 12 upon acquiring the operation command S1 from the master controller 91. Processing in steps S11 and S12 is similar to that executed in steps S11 and S12 by the control device 20 according to Embodiment 1 that is illustrated in FIG. 4.

The abnormality determiner 32 acquires the temperatures of the power conversion devices 11 and 12 from the temperature detectors 95 and 96 (step S31). The abnormality determiner 32 determines whether the temperatures of the power conversion device 11 and 12 are within the second target temperature range (step S32).

When the temperatures of the power conversion device 11 and 12 are within the second target temperature range (YES in step S32), the abnormality determiner 32 executes the processing in steps S13 through S15 similarly to Embodiment 1. When at least one of the temperatures of the power conversion devices 11 and 12 is not within the second target temperature range (NO in step S32), the abnormality determiner 32 outputs, to the external device, the determination result indicating non-occurrence of abnormality (step S16). After completion of the processing in step S15 or step S16, the control device 23 repeats the aforementioned processing from step S11.

As described above, the second calculators 41 and 43 included in the control device 23 according to Embodiment 3 adjust the basic torque command value based on the parameters indicating the temperatures of the power conversion devices 11 and 12 and thereby determine the shaft torque command values. As described above, the shaft torque command values for the temperatures of the power conversion devices 11 and 12 that are higher than the third target temperature range are made to be less than the shaft torque command values for the temperatures of the power conversion devices 11 and 12 that are within the third target temperature range, leading to suppression of an increase in the temperatures of the power conversion devices 11 and 12.

When the temperatures of the power conversion devices 11 and 12 are not within the second target temperature range, the abnormality determiner 32 does not make a determination of presence or absence of abnormality in the transmission lines L1 and L2 and the second calculators 41 and 43, and outputs the determination result indicating non-occurrence of abnormality in the transmission lines L1 and L2 and the second calculator 41 and 43. This suppresses erroneously determining that abnormality is occurring in at least one of the transmission line L1, the transmission line L2, the second calculator 41, or the second calculator 43 when the shaft torque command values Tr1 and Tr2 are set low due to the temperatures of the power conversion devices 11 and 12 not being within the second target temperature range.

### Embodiment 4

The method for determining the shaft torque command values and the abnormality determination method are not limited to the above examples. In Embodiment 4, a control device 25 that determines the shaft torque command values and determines presence or absence of abnormality in methods different from the methods of Embodiments 1-3 is described focusing on differentiating points from Embodiments 1-3.

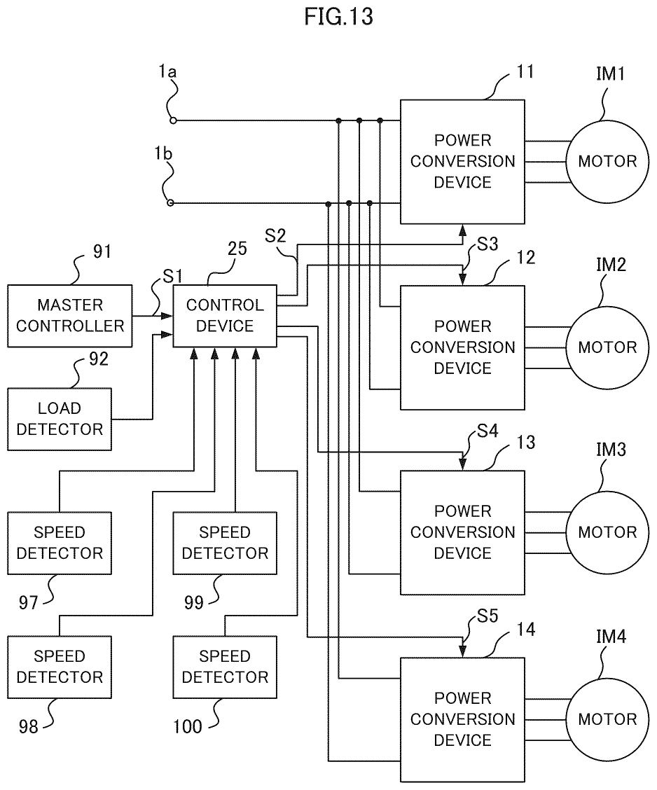

The control device 25 illustrated in FIG. 13 is arranged at each motor coach. The control device 25 sends control signals S2, S3, S4 and S5 to power conversion devices 11, 12, 13 and 14, respectively, to control the power conversion devices 11, 12, 13 and 14. The power conversion devices 11 and 12 controlled by the control device 25 supply electric power to motors IM1 and IM2 attached to one bogie of the motor coach. The power conversion devices 13 and 14 controlled by the control device 25 supply electric power to motors IM3 and IM4 attached to the other bogie of the motor coach. The power conversion devices 11, 12, 13 and 14 have the same configuration. The motors IM1, IM2, IM3, and IM4 have the same configuration.

The control device 25 acquires, from speed detectors 97, 98, 99 and 100 that determine rotational speeds of the motors IM1, IM2, IM3 and IM4, the rotational speeds of the motors IM1, IM2, IM3 and IM4. The speed detectors 97, 98, 99 and 100 determine the rotational speeds of the motors IM1, IM2, IM3 and IM4 based on signals output from pulse generators (PG) arranged at positions adjacent to shafts of the motors IM1, IM2, IM3 and IM4.

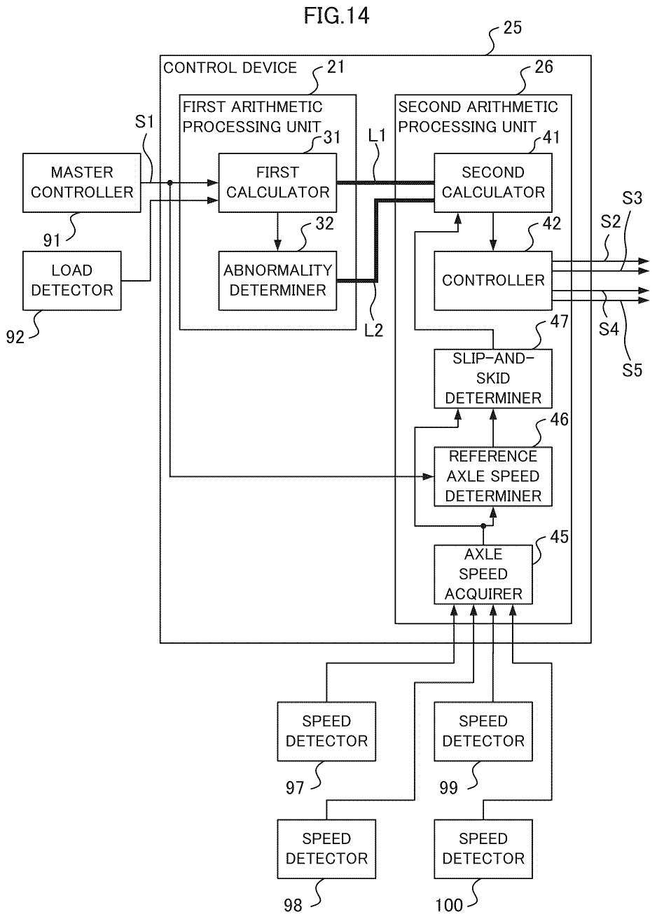

As illustrated in FIG. 14, the control device 25 includes a first arithmetic processing unit 21 and a second arithmetic processing unit 26 that are connected to each other via transmission lines L1 and L2. The second arithmetic processing unit 26 includes, in addition to the elements of the second arithmetic processing unit 22 included in the control device 20 according to Embodiment 1, an axle speed acquirer 45 that determines axle speeds each for a corresponding axle of the vehicle based on the rotational speeds of the motors IM1, IM2, IM3 and IM4, a reference axle speed determiner 46 that determines a reference axle speed based on each of the axle speeds, and a slip-and-skid determiner 47 that determines presence or absence of slip or skid based on each of the axle speeds and the reference axle speed.

The axle speeds change depending on the rotational speeds of the wheels attached to the axles that each receive a torque via a gear device from a corresponding shaft of the shafts of the motors IM1, IM2, IM3 and IM4. The axle speed acquirer 45 calculates, from the rotational speeds of the motors IM1, IM2, IM3 and IM4, for each of the axles, a circumferential speed of the wheels attached to the axle. The axle speed acquirer 45, sends, as the axle speeds, the circumferential speeds of the wheels that are each calculated for a corresponding axle, to the reference axle speed determiner 46 and the slip-and-skid determiner 47.

The reference axle speed determiner 46 acquires from the axle speed acquirer 45 the axle speeds that are each determined for a corresponding axle, and acquires the operation command S1 from the master controller 91. The reference axle speed determiner 46 determines, based on the axle speeds that are each for a corresponding axle of the vehicle, the reference axle speed in the vehicle. In detail, in the case where the operation command S1 indicates the power running command, the reference axle speed determiner 46 determines, as the reference axle speed, a minimum value of the axle speeds that are each for a corresponding axle of the vehicle. In the case where the operation command S1 indicates the braking command, the reference axle speed determiner 46 determines, as the reference axle speed, a maximum value of the axle speeds that are each for a corresponding axle of the vehicle. The reference axle speed determiner 46 sends the reference axle speed determined as above to the slip-and-skid determiner 47.

The slip-and-skid determiner 47 determines, for each of the axles, based on a comparison between a corresponding axle speed and the reference axle speed, a degree of slip or skid of the wheels attached to the axle. In Embodiment 4, the slip-and-skid determiner 47 determines whether an absolute value of a difference between the corresponding axle speed and the reference axle speed is greater than or equal to a speed difference threshold. The speed difference threshold is defined, through simulation or test driving of the railroad vehicle, based on possible values of a difference between the axle speed and the reference axle speed during occurrence of slip or skid. In the case of an axle with the absolute value of the difference between the axle speed and the reference axle speed being greater than or equal to the speed difference threshold, it can be deemed that slip or skid is occurring at the wheel attached to this axle. The slip-and-skid determiner 47 sends, to the second calculator 41, a determination result for each of the axles. The slip-and-skid determiner 47 sends the determination result to the abnormality determiner 32 via the transmission line L2.

The second calculator 41 adjusts the basic torque command value based on parameters indicating the determination results of the slip-and-skid determiner 47 and thereby determines the shaft torque command value for each of the motors IM1, IM2, IM3 and IM4. In detail, the second calculator 41 calculates the shaft torque command value for each of the motors IM1, IM2, IM3 and IM4 by multiplying the basic torque command value by the parameter indicating the wheel diameter of the wheels that rotate with a torque obtained from a corresponding one of the motors IM1, IM2, IM3 and IM4 and by a parameter indicating a corresponding determination result of the slip-and-skid determiner 47.

In one example, the second calculator 41 calculates a shaft torque command value Tr1 for the motor IM1 by multiplying a basic torque command value Tr0 by a parameter R1 indicating the wheel diameter of the wheels corresponding to the motor IM1 and by a parameter D1 indicating the determination result of the slip-and-skid determiner 47 for the axle corresponding to the motor IM1. The shaft torque command value Tr1 is expressed as Tr1=Tr0×R1×D1.

Similarly, the second calculator 41 calculates a shaft torque command value Tr2 for the motor IM2 by multiplying the basic torque command value Tr0 by a parameter R2 indicating the wheel diameter of the wheels corresponding to the motor IM2 and by a parameter D2 indicating the determination result of the slip-and-skid determiner 47 for the axle corresponding to the motor IM2. The shaft torque command value Tr2 is expressed as Tr2=Tr0×R2×D2.

Similarly, the second calculator 41 calculates a shaft torque command value Tr3 for the motor IM3 by multiplying the basic torque command value Tr0 by a parameter R3 indicating the wheel diameter of the wheels corresponding to the motor IM3 and by a parameter D3 indicating the determination result of the slip-and-skid determiner 47 for the axle corresponding to the motor IM3. The shaft torque command value Tr3 is expressed as Tr3=Tr0×R3×D3.

Similarly, the second calculator 41 calculates a shaft torque command value Tr4 for the motor IM4 by multiplying the basic torque command value Tr0 by a parameter R4 indicating the wheel diameter of the wheels corresponding to the motor IM4 and by a parameter D4 indicating the determination result of the slip-and-skid determiner 47 for the axle corresponding to the motor IM4. The shaft torque command value Tr4 is expressed as Tr4=Tr0×R4×D4.

The parameters D1, D2, D3 and D4 each indicating the determination result of the slip-and-skid determiner 47 indicate 1 when a determination is made by the slip-and-skid determiner 47 that neither slip nor skid is occurring, and indicate a value greater than or equal to 0 and less than 1 when a determination is made by the slip-and-skid determiner 47 that slip or skid is occurring. For example, the second calculator 41 may acquire the determination results from the slip-and-skid determiner 47 at regular time intervals and gradually decrease the parameters D1, D2, D3 and D4 from 1 to 0 when the determination results indicate that slip or skid is occurring. The second calculator 41 is taken to hold, in advance, information of the parameters.

When slip or skid is occurring, since the parameters D1, D2, D3 and D4 are a value less than 1, the shaft torque command values Tr1, Tr2, Tr3 and Tr4 become small as compared to the case where neither slip nor skid is occurring. As the shaft torque command values Tr1, Tr2, Tr3 and Tr4 become smaller, the actual torque of the motors IM1, IM2, IM3 and IM4 become smaller, leading to re-adhesion of the wheels.

The second calculator 41 transmits the shaft torque command values Tr1, Tr2, Tr3 and Tr4 determined as above to the abnormality determiner 32 via the transmission line L2.

The second calculator 41 sends the determination results acquired from the slip-and-skid determiner 47 and the shaft torque command values Tr1, Tr2, Tr3 and Tr4 determined as above to the abnormality determiner 32 via the transmission line L2.

The abnormality determiner 32 determines, when the operating status satisfies a determination condition, based on the basic torque command value acquired from the first calculator 31 and the shaft torque command values acquired from the second calculator 41, presence or absence of abnormality in at least one of the transmission line L1, the transmission line L2, or the second calculator 41. In detail, when neither slip nor skid is occurring, the abnormality determiner 32 determines whether the basic torque command value Tr0 and each of the shaft torque command values Tr1, Tr2, Tr3 and Tr4 match. For example, when the determination results acquired from the second calculator 41 indicate that neither slip nor skid is occurring, the abnormality determiner 32 determines, based on differences between the basic torque command value Tr0 and each of the shaft torque command values Tr1, Tr2, Tr3 and Tr4, presence or absence of abnormality in at least one of the transmission line L1, the transmission line L2, or the second calculator 41.

When slip or skid is occurring in at least one wheel, the abnormality determiner 32 does not make a determination of presence or absence of abnormality based on the differences between the basic torque command value Tr0 and each of the shaft torque command values Tr1, Tr2, Tr3 and Tr4. This suppresses erroneously determining that abnormality is occurring in at least one of the transmission line L1, the transmission line L2, or the second calculator 41 when at least one of the shaft torque command values Tr1, Tr2, Tr3 and Tr4 is set low due to the occurrence of slip or skid.

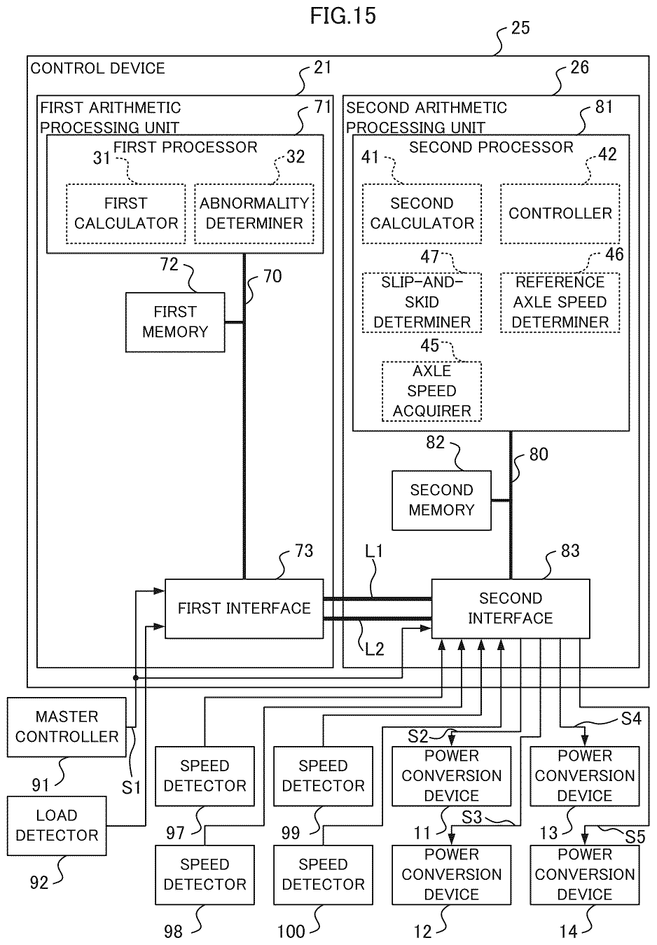

FIG. 15 illustrates hardware configuration of the control device 25 having the above configuration. The control device 25 has the same hardware configuration as that in Embodiment 1.

The second processor 81 reads and executes the programs stored in the second memory 82 to achieve the functions of the second arithmetic processing unit 26, more specifically, the functions of the second calculator 41, the controller 42, the axle speed acquirer 45, the reference axle speed determiner 46, and slip-and-skid determiner 47. That is, the second memory 82 stores programs for execution of the processing by the control device 25.

The second arithmetic processing unit 26 is connected to the speed detectors 97, 98, 99 and 100 and the power conversion devices 11, 12, 13 and 14 via the second interface 83. The second interface 83 includes an interface module complying with one or more standards as appropriate for connection targets.

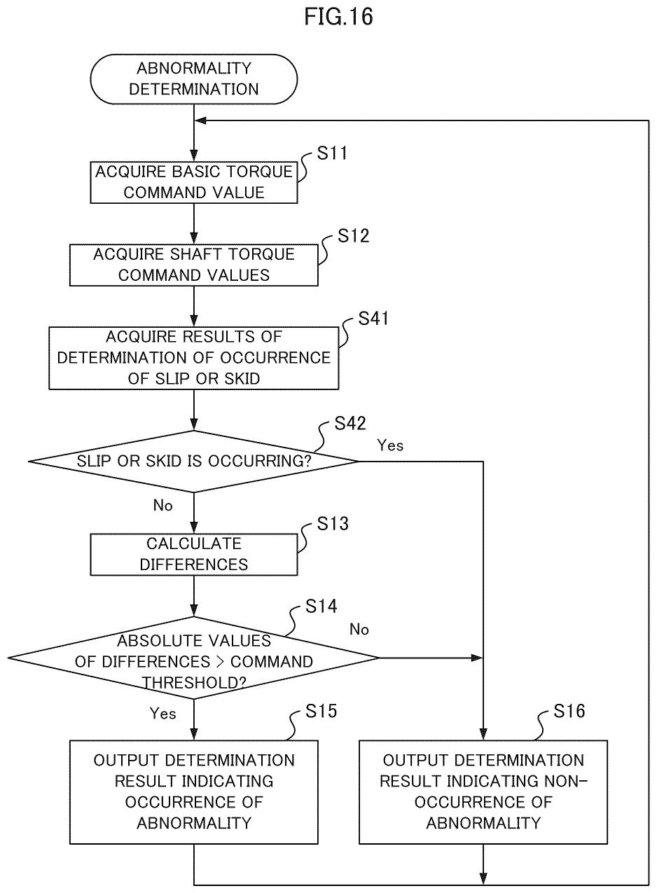

The abnormality determination processing executed by the control device 25 having the aforementioned configuration is described with reference to FIG. 16. The control device 25 starts the operation illustrated in FIG. 16 upon acquiring the operation command S1 from the master controller 91. Processing in steps S11 and S12 is similar to that executed in steps S11 and S12 by the control device 20 according to Embodiment 1 that is illustrated in FIG. 4.

The abnormality determiner 32 acquires the determination results of the slip-and-skid determiner 47 via the transmission line L2 (step S41). When neither slip nor skid is occurring (NO in step S42), the abnormality determiner 32 executes the processing in steps S13 through S15 similarly to Embodiment 1. When at least one of slip or skid is occurring (YES in step S42), the abnormality determiner 32 outputs, to the external device, the determination result indicating non-occurrence of abnormality (step S16). After completion of the processing in step S15 or step S16, the control device 25 repeats the aforementioned processing from step S11.

As described above, the second calculator 41 included in the control device 25 according to Embodiment 4 adjusts the basic torque command value based on the parameters each indicating the determination result of the slip-and-skid determiner 47 and thereby determines the shaft torque command values. As described above, the shaft torque command values for the case of occurrence of slip or skid are made to be less than the shaft torque command values for the case where neither slip nor skid is occurring, enabling re-adhesion.

When slip or skid is occurring, the abnormality determiner 32 does not make a determination of presence or absence of abnormality in the transmission lines L1 and L2 and the second calculator 41, and outputs the determination result indicating non-occurrence of abnormality in the transmission lines L1 and L2 and the second calculator 41. This suppresses erroneously determining that abnormality is occurring in at least one of the transmission line L1, the transmission line L2, or the second calculator 41 when the shaft torque command values Tr1 and Tr2 are set low due to the occurrence of slip or skid.

### Embodiment 5

The method for determining the shaft torque command values and the abnormality determination method are not limited to the above examples. In Embodiment 5, a control device 20 that determines the shaft torque command values and determines presence or absence of abnormality in methods different from the methods of Embodiments 1-4 is described focusing on differentiating points from Embodiments 1-4.

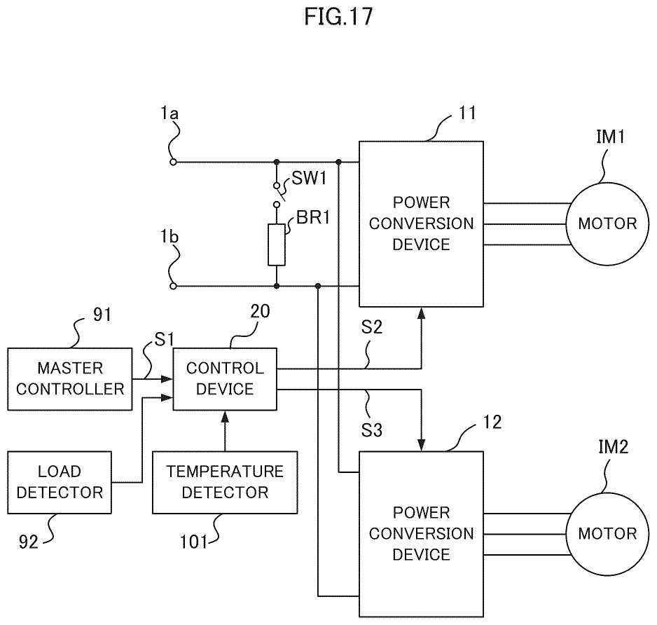

In Embodiment 5, the railroad vehicle obtains a braking force not by regenerative braking, but by dynamic braking using a brake resistor BR1 illustrated in FIG. 17. In detail, a switch SW1 and the brake resistor BR1 connected in series are arranged closer to the power source than the power conversion devices 11 and 12 between the terminals 1a and 1b. The switch SW1 is closed and opened by a non-illustrated switch controller.

Upon the switch SW1 being closed for braking of the railroad vehicle, the power conversion devices 11 and 12 are electrically connected to the brake resistor BR1. The electric power supplied from the motors IM1 and IM2 operating as power generators is thus consumed by the brake resistor BR1, thereby generating an electric braking force. Upon consumption of the electric power by the brake resistor BR1, the brake resistor BR1 generates heat. While the railroad vehicle is in power running or in coasting operation, since the switch SW1 is maintained in an opened state, the brake resistor BR1 does not generate heat.

The control device 20 acquires, from a temperature detector 101 that determines a temperature of the brake resistor BR1, the temperature of the brake resistor BR1. For example, the temperature detector 101 estimates the temperature of the brake resistor BR1 from a measurement value of a current sensor that measures a value of current flowing in the brake resistor BR1.

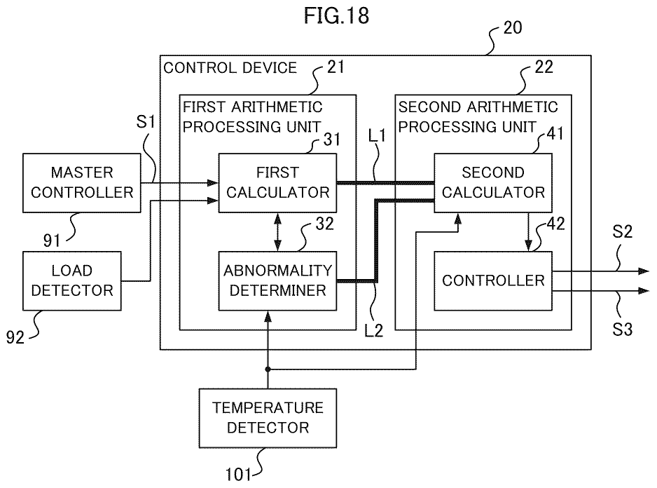

As illustrated in FIG. 18, the configuration of the control device 20 is similar to that of Embodiment 1. Each of the abnormality determiner 32 and the second calculator 41 acquires the temperature of the brake resistor BR1 from the temperature detector 101.

The second calculator 41 adjusts the basic torque command value based on a parameter indicating the temperature of the brake resistor BRI and thereby determines the shaft torque command value for each of the motors IM1 and IM2. In detail, the second calculator 41 calculates the shaft torque command value for each of the motors IM1 and IM2 by multiplying the basic torque command value by the parameter indicating the wheel diameter of the wheels that rotate with a torque obtained from a corresponding one of the motors IM1 and IM2 and by the parameter indicating the temperature of the brake resistor BR1.

In one example, the second calculator 41 calculates a shaft torque command value Tr1 by multiplying a basic torque command value Tr0 by a parameter R1 indicating the wheel diameter of the wheels corresponding to the motor IMI and by a parameter ThB indicating the temperature of the brake resistor BR1. The shaft torque command value Tr1 is expressed as Tr1=Tr0×R1×ThB. The second calculator 41 calculates a shaft torque command value Tr2 by multiplying the basic torque command value Tr0 by a parameter R2 indicating the wheel diameter of the wheels corresponding to the motor IM2 and by the parameter ThB indicating the temperature of the brake resistor BR1. The shaft torque command value Tr2 is expressed as Tr2=Tr0×R2×Thb.

The parameter ThB indicating the temperature of the brake resistor BR1 is a value greater than or equal to 0 and less than or equal to 1, and is a parameter negatively correlated with the temperature of the brake resistor BR1 at a high-temperature range. In detail, when the temperature of the brake resistor BR1 is within a third target temperature range, the parameter ThB is 1, and when the temperature of the brake resistor BR1 is higher than the third target temperature range, the parameter ThB is less than 1. As the temperature of the brake resistor BRI increases above an upper limit of the third target temperature range, the value of the parameter ThB approaches 0. The third target temperature range is set lower than an allowable temperature of the brake resistor BR1, in other words, a temperature that the brake resistor BR1 can withstand. The second calculator 41 is taken to hold, in advance, information of the parameters and the third target temperature range.

When the temperature of the brake resistor BR1 is higher than the third target temperature range, since the parameter ThB is a value less than 1, the shaft torque command values Tr1 and Tr2 become small as compared to the case where the temperature of the brake resistor BR1 is within the target temperature range. A decrease in the shaft torque command values Tr1 and Tr2 leads to a decrease in currents flowing into the brake resistor BR1 from the power conversion device 11 controlled with the control signals S2 and S3 for achieving torques indicated by the shaft torque command values Tr1 and Tr2, resulting in suppression of an increase in the temperature of the brake resistor BR1.

The second calculator 41 transmits the shaft torque command values Tr1 and Tr2 determined as above to the abnormality determiner 32 via the transmission line L2.

The abnormality determiner 32 determines, when the operating status satisfies a determination condition, based on the basic torque command value acquired from the first calculator 31 and the shaft torque command values acquired from the second calculator 41, presence or absence of abnormality in at least one of the transmission line L1, the transmission line L2, or the second calculator 41. In detail, when the temperature of the brake resistor BR1 is within the third target temperature range, the abnormality determiner 32 determines whether the basic torque command value Tr0 and each of the shaft torque command values Tr1 and Tr2 match. For example, when the temperature of the brake resistor BR1 is within the third target temperature range, the abnormality determiner 32 determines, based on differences between the basic torque command value Tr0 and each of the shaft torque command values Tr1 and Tr2, presence or absence of abnormality in at least one of the transmission line L1, the transmission line L2, or the second calculator 41. The abnormality determiner 32 is taken to hold, in advance, information of the third target temperature range.

When the temperature of the brake resistor BR1 is not within the third target temperature range, the abnormality determiner 32 does not make a determination of presence or absence of abnormality based on the differences between the basic torque command value Tr0 and each of the shaft torque command values Tr1 and Tr2. This suppresses erroneously determining that abnormality is occurring in at least one of the transmission line L1, the transmission line L2, or the second calculator 41 when the shaft torque command values Tr1 and Tr2 are set low due to the temperature of the brake resistor BR1 not being within the third target temperature range.

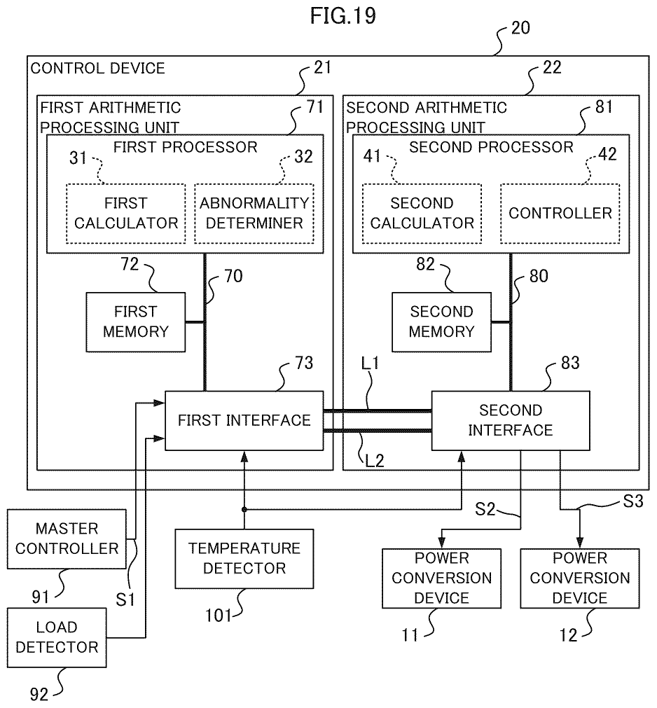

FIG. 19 illustrates hardware configuration of the control device 20 having the above configuration. The control device 20 has the same hardware configuration as that in Embodiment 1.

The first arithmetic processing unit 21 is connected to the master controller 91, the load detector 92, and the temperature detector 101, via the first interface 73. The first interface 73 includes an interface module complying with one or more standards as appropriate for connection targets.

The second arithmetic processing unit 22 is connected to the temperature detector 101 and the power conversion devices 11 and 12 via a second interface 83. The second interface 83 includes an interface module complying with one or more standards as appropriate for connection targets.

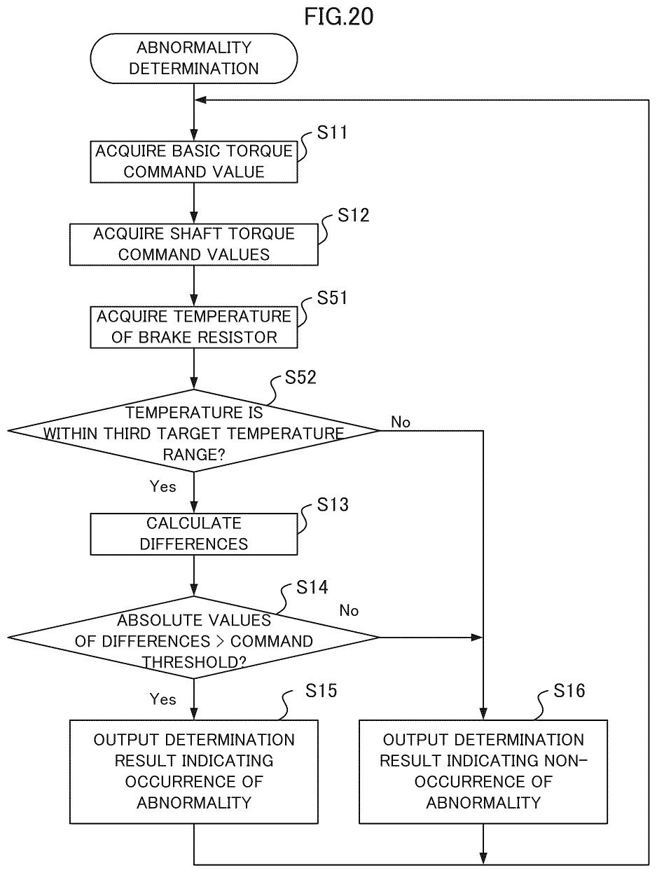

The abnormality determination processing executed by the control device 20 having the aforementioned configuration is described with reference to FIG. 20. The control device 20 starts the operation illustrated in FIG. 20 upon acquiring the operation command S1 from the master controller 91. Processing in steps S11 and S12 is similar to that executed in steps S11 and S12 by the control device 20 according to Embodiment 1 that is illustrated in FIG. 4.

The abnormality determiner 32 acquires the temperature of the brake resistor BR1 from the temperature detector 101 (step S51). The abnormality determiner 32 determines whether the temperature of the brake resistor BR1 is within the third target temperature range (step S52).

When the temperature of the brake resistor BR1 is within the third target temperature range (YES in step S52), the abnormality determiner 32 executes the processing in steps S13 through S15 similarly to Embodiment 1. When the temperature of the brake resistor BR1 is not within the target temperature range (NO in step S52), the abnormality determiner 32 outputs a determination result indicating non-occurrence of abnormality to the external device (step S16). After completion of the processing in step S15 or step S16, the control device 20 repeats the aforementioned processing from step S11.

As described above, the second calculator 41 included in the control device 20 according to Embodiment 5 adjusts the basic torque command value based on the parameter indicating the temperature of the brake resistor BR1 and thereby determines the shaft torque command values. As described above, the shaft torque command value for the temperature of the brake resistor BRI that is higher than the third target temperature range is made to be less than the shaft torque command values for the temperature of the brake resistor BR1 that is within the third target temperature range, leading to suppression of an increase in the temperature of the brake resistor BR1.

When the temperature of the brake resistor BR1 is not within the third target temperature range, the abnormality determiner 32 does not make a determination of presence or absence of abnormality in the transmission lines L1 and L2 and the second calculator 41, and outputs the determination result indicating non-occurrence of abnormality in the transmission lines L1 and L2 and the second calculator 41. This suppresses erroneously determining that abnormality is occurring in at least one of the transmission line L1, the transmission line L2, or the second calculator 41 when the shaft torque command values Tr1 and Tr2 are set low due to the temperature of the brake resistor BR1 not being within the third target temperature range.

The present disclosure is not limited to the above embodiments. Any of the aforementioned embodiments may be freely combined. The abnormality determiner 32 included in the control device 20 may acquire, from the temperature detectors 93, 94, 95 and 96, the temperatures of the motors IM1 and IM2 and the temperatures of the power conversion devices 11 and 12. When at least one of the temperatures of the motors IM1 and IM2 is not within the first target temperature range or at least one of the temperatures of the power conversion devices 11 and 12 is not within the second target temperature range, the abnormality determiner 32 may output the determination result indicating non-occurrence of abnormality in the transmission lines L1 and L2 and the second calculator 41.

In another example, the abnormality determiner 32 may output the determination result indicating non-occurrence of abnormality in the transmission lines L1 and L2 and the second calculator 41 when at least one of the temperatures of the motors IM1 and IM2 is not within the first target temperature range, at least one of the temperatures of the power conversion devices 11 and 12 is not within the second target temperature range, or slip or skid is occurring.

The abnormality determiner 32 according to Embodiments 3-5 may send the determination result to the first calculator 31, similarly to Embodiment 2.

The above-described circuits and flowcharts are mere examples. In one example, the processing in step S11 and the processing in step S12 of FIG. 4 may be executed in parallel. The processing in step S21 of FIG. 8 that is the acquisition of the temperatures of the motors IM1 and IM2 from the temperature detectors 93 and 94 by the abnormality determiner 32 may be executed in parallel with steps S11 and S12. Similarly, the processing in step S31 of FIG. 12, the processing in step S41 of FIG. 16, and the processing in step S51 of FIG. 20 may be executed in parallel with steps S11 and S12.

In another example, the abnormality determiner 32 according to Embodiment 2 may perform the calculation of the differences in step S13 at every execution of processing. In this example, the abnormality determiner 32 may output the determination result indicating non-occurrence of abnormality without the comparison between the difference and the command threshold when at least one of the temperatures of the motors IM1 and IM2 is not within the first target temperature range. The same applies to the Embodiments 3-5.

The abnormality determiner 32 may determine presence or absence of abnormality in at least one of the transmission line L1, the transmission line L2, or the second calculator 41, based on ratios, to the basic torque command value, of the differences between the basic torque command value and each of the shaft torque command values. In this case, the abnormality determiner 32 may determine whether the above ratios are within an acceptable error range, such as a range between −0.1 and 0.1.

The abnormality determiner 32 may determine presence or absence of abnormality in at least one of the transmission line L1, the transmission line L2, or the second calculator 41 based on ratios of each of the shaft torque command values to the basic torque command value. In this case, the abnormality determiner 32 may determine whether the above ratios are within an acceptable error range, such as a range between −0.9 and 1.1.

The temperature detectors 93 and 94 may estimate the temperatures of the motors IM1 and IM2 from measurement values of currents flowing in the stator coils of the motors IM1 and IM2.

The speed detectors 97, 98, 99 and 100 may estimate the rotational speeds of the motors IM1, IM2, IM3 and IM4 from measurement values of currents flowing in the motors IM1, IM2, IM3 and IM4 and voltage commands directed to the power conversion devices 11, 12, 13 and 14.

The temperature detector 101 may determine the temperature of the brake resistor BR1 based on a measurement value of a temperature sensor arranged at a position adjacent to the brake resistor BR1.

The first arithmetic processing unit 21 and the second arithmetic processing unit 22 may transmit and receive data via the transmission line L1. In detail, the first calculator 31 of the first arithmetic processing unit 21 may transmit the basic torque command value to the second calculator 41 of the second arithmetic processing unit 22 via the transmission line L1, and the second calculator 41 may transmit the shaft torque command values to the abnormality determiner 32 via the transmission line L1.

The power conversion devices 11 and 12 may be installable in a railroad vehicle that employs an alternating-current feeding system. In this case, alternating-current acquired by the power collector may be stepped down by a transformer and supplied to the power conversion devices 11 and 12. Any device may be used as the power conversion device 11 and 12 that includes a converter that converts alternating-current into direct-current, a capacitor that is charged with direct-current power supplied from the converter, and an inverter that converts the direct-current power supplied via the capacitor into three-phase alternating-current power.

The motors IM1, IM2, IM3 and IM4 are not limited to a three-phase induction motor and may be any motor that is controllable with vector control.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1a, 1b Terminal

11, 12, 13, 14 Power conversion device

20, 23, 25 Control device

21 First arithmetic processing unit

22, 24, 26 Second arithmetic processing unit

31 First calculator

32 Abnormality determiner

41, 43 Second calculator

42, 44 Controller

45 Axle speed acquirer

46 Reference axle speed determiner

47 Slip-and-skid determiner

70, 80 Bus

71 First processor

72 First memory

73 First interface

81, 84 Second processor

82 Second memory

83 Second interface

91 Master controller

92 Load detector

93, 94, 95, 96, 101 Temperature detector

97, 98, 99, 100 Speed detector

BR1 Brake resistor

IM1, IM2, IM3, IM4 Motor

L1, L2 Transmission line

S1 Operation command

S2, S3, S4, S5 Control signal

SW1 Switch

1. A control device for controlling power conversion devices that are installable in a railroad vehicle and include switching elements, each of the power conversion devices being to convert electric power inputted thereto into electric power to be supplied to one or more motors and supply the electric power resulting from the conversion to the one or more motors, the control device comprising:
first arithmetic processing circuitry and second arithmetic processing circuitry that are connected to each other via a transmission line, wherein
the first arithmetic processing circuitry includes first calculating circuitry to determine, for each vehicle of the railroad vehicle, based on a target acceleration of the railroad vehicle and a weight of the vehicle, a basic torque command value that is a torque command value common to the motors arranged in the vehicle,
the second arithmetic processing circuitry includes second calculating circuit to adjust, based on a parameter indicating at least one of an operating status of a device installed in the railroad vehicle or wheel diameters of wheels rotatable with torques transmitted from the motors, the basic torque command value acquired from the first calculating circuitry via the transmission line, and thereby determine, for each of the power conversion devices, a shaft torque command value that is a torque command value for the one or more motors that are to receive the electric power supplied from the power conversion device,
the second arithmetic processing circuitry includes controlling circuitry to generate control signals that are each for achieving a torque indicated by a corresponding one of a plurality of the shaft torque command values and that are each directed to the switching elements included in a corresponding one of the power conversion devices, and output the control signals, and
the first arithmetic processing circuitry includes abnormality determining circuitry to determine, based on the basic torque command value and the plurality of shaft torque command values, presence or absence of abnormality in at least one of the transmission line or the second calculating circuitry.

2. The control device according to claim 1, wherein
the abnormality determining circuitry determines, when the operating status satisfies a determination condition, whether the basic torque command value and each of the plurality of shaft torque command values match.

3. The control device according to claim 1, wherein
the operating status includes at least one of temperatures of the motors, temperatures of the power conversion devices, presence or absence of slip or skid of wheels attached to axles of the railroad vehicle, or a temperature of a brake resistor configured to consume electric power that is output from the motors operating as power generators during deceleration of the railroad vehicle and that is converted by the power conversion devices so as to generate an electric braking force.

4. The control device according to claim 3, wherein
the parameter comprises a plurality of the parameters indicating the temperatures of motors, and
the second calculating circuitry adjusts the basic torque command value based on the plurality of parameters indicating the temperatures of the motors and thereby determines the plurality of shaft torque command values.

5. The control device according to claim 4, wherein
the abnormality determining circuitry acquires the temperatures of the motors as the operating status, and when the temperatures of the motors are within a first target temperature range defined based on an allowable temperature of the motors, determines presence or absence of abnormality in at least one of the transmission line or the second calculating circuitry, based on the basic torque command value and the plurality of shaft torque command values.

6. The control device according to claim 3, wherein
the parameter comprises a plurality of the parameters indicating the temperatures of the power conversion devices, and
the second calculating circuitry adjusts the basic torque command value based on the plurality of parameters indicating the temperatures of the power conversion devices and thereby determines the plurality of shaft torque command values.

7. The control device according to claim 6, wherein
the abnormality determining circuitry acquires the temperatures of the power conversion devices as the operating status, and when the temperatures of the power conversion devices are within a second target temperature range defined based on an allowable temperature of the power conversion devices, determines presence or absence of abnormality in at least one of the transmission line or the second calculating circuitry, based on the basic torque command value and the plurality of shaft torque command values.

8. The control device according to claim 3, wherein
the parameter indicates the temperature of the brake resistor, and
the second calculating circuitry calculator adjusts the basic torque command value based on the parameter indicating the temperature of the brake resistor and thereby determines the plurality of shaft torque command values.

9. The control device according to claim 8, wherein
the abnormality determining circuitry acquires the temperature of the brake resistor as the operating status, and when the temperature of the brake resistor is within a third target temperature range defined based on an allowable temperature of the brake resistor, determines presence or absence of abnormality in at least one of the transmission line or the second calculating circuitry, based on the basic torque command value and the plurality of shaft torque command values.

10. The control device according to claim 3, wherein
the first arithmetic processing circuitry further includes axle speed acquiring circuitry to acquire, for each of the axles of the vehicle, an axle speed that changes depending on a rotational speed of the wheels attached to the axle,
reference axle speed determining circuitry to determine, as a reference axle speed of the vehicle, a minimum value or a maximum value of a plurality of the axle speeds that are each for a corresponding axle of the axles of the vehicle, and
slip-and-skid determining circuitry to determine, for each of the axles, based on a comparison between a corresponding axle speed and the reference axle speed, a degree of slip or skid of the wheels attached to the axle,
the parameter indicates a determination result of the slip-and-skid determining circuitry, and
the second calculating circuitry adjusts the basic torque command value based on the parameter indicating the determination result of the slip-and-skid determining circuitry and thereby determines the plurality of shaft torque command values.

11. The control device according to claim 10, wherein
the abnormality determining circuitry acquires the determination result of the slip-and-skid determining circuitry as the operating status, and when the determination result of the slip-and-skid determining circuitry indicates that neither slip nor skid is occurring, determines presence or absence of abnormality in at least one of the transmission line or the second calculating circuitry, based on the basic torque command value and the plurality of shaft torque command values.

12. The control device according to claim 1, wherein
when the abnormality determining circuitry determines that abnormality is occurring in at least one of the transmission line or the second calculating circuitry, the first calculating circuitry sets the basic torque command value to a value to stop the power conversion devices.

13. The control device according to claim 1, wherein
the transmission line includes
a first transmission line for transmission of the basic torque command value from the first calculating circuitry to the second calculating circuitry, and
a second transmission line for transmission of the plurality of shaft torque command values from the second calculating circuitry to the abnormality determining circuitry, wherein
the first transmission line and the second transmission line are arranged separately.

14. The control device according to claim 1, wherein
the first arithmetic processing circuitry includes
one or more first processors,
one or more first memories that store a command for causing the one or more first processors to function as the first calculating circuitry and the abnormality determining circuitry, and
a first interface to communicate with the second arithmetic processing circuitry via the transmission line.

15. The control device according to claim 1, wherein
the second arithmetic processing circuitry includes
one or more second processors,
one or more second memories that store a command for causing the one or more second processors to function as the second calculating circuitry and the controlling circuitry, and
a second interface to communicate with the first arithmetic processing circuitry via the transmission line.

16. An abnormality determination method performed by a control device for controlling power conversion devices that are installable in a railroad vehicle and include switching elements, each of the power conversion devices being to convert electric power inputted thereto into electric power to be supplied to one or more motors and supply the electric power resulting from the conversion to the one or more motors, the control device including first arithmetic processing circuitry and second arithmetic processing circuitry that are connected to each other via a transmission line, the abnormality determination method comprising:
determining presence or absence of abnormality in at least one of the transmission line or the second arithmetic processing circuitry based on a basic torque command value and shaft torque command values, the basic torque command value being determined in the first arithmetic processing circuitry, for each vehicle of the railroad vehicle, based on a target acceleration of the railroad vehicle and a weight of the vehicle, and being a torque command value common to the motors arranged in the vehicle, the shaft torque command values being determined in the second arithmetic processing circuitry by adjusting the basic torque command value based on a parameter indicating at least one of an operating status of a device installed in the railroad vehicle or wheel diameters of wheels rotatable with torques transmitted from the motors, each of the shaft torque command values being a torque command value for a corresponding one of the one or more motors that are to receive the electric power supplied from the power conversion device.
